(19) United States
(12) Patent Application Publication
(10) Pub. No.: US 2009/0032317 A1
(43) Pub. Date: Feb. 5, 2009

(54) Superefficient hydraulic hybrid powertrain and method of operation

(76) Inventor: Grigoriy Epshteyn, New York, NY (US)

Correspondence Address: Grigoriy Epshteyn, 7 Old Scots Road, Marlboro, NJ, 07746, US

(21) Appl. No.: 11/881,940

(22) Filed: Jul. 30, 2007

(51) Int. Cl. B60K 6/36; F16H 37/06

(52) U.S. Cl. 180/65.2; 475/5; 903/915

(57) ABSTRACT

Super efficient hydraulic powertrain of vehicle includes two different size variable displacement monocylindrical hybrids engine, compressor and pump. Unique features such as wide range of continuously changing displacement proportional to fuel supply per cycle; load stabilizer; pump plunger fastened to engine piston with direct energy transfer and greater hybrid activating and deactivating provides minimum specific fuel consumption and constant engine load independent of required power change from idling to maximum.

Total energy recuperation including regenerative braking and regenerative acceleration decreases prime mover size at least 1.5 times and preserves acceleration magnitude of conventional car. Extremely compact design of prime mover arranged along one side of vehicle creates cost-effective seven seats mid-size car instead of five seats without change of overall width and length of standard car with driver seat located at vehicle fore and despite of 1500 kg vehicle weight enables to achieve at least 80 mpg in city conditions.

### CROSS-REFERENCE TO RELATED APPLICATIONS

Not Applicable

### FEDERALLY SPONSORED RESEARCH

Not Applicable

### SEQUENCE OF THE INVENTION

Not Applicable

### BACKGROUND OF THE INVENTION

1. Field of Invention

This invention relates to the automotive systems of variable displacement hybrid internal combustion engine, compressor and pump and progressive hydrostatic transmission integration associated with energy recuperation hydraulic or electric system, which are used for high efficiency and unique compact automotive driving.

2. Background of the Invention

The widespread hydrostatic transmission is used to drive wheels and working equipment of widely known machinery-mountainous, construction, agricultural, transportation automotive and other heavy equipment.

Also widely know hybrid cars with engine and power electric units combination.

By way of example, U.S. Pat. No. 5,556,262 to Achten et al. (1996), U.S. Pat. No. 5,495,912 to Gray (1996), U.S. Pat. No. 5,616,010 to Sawyer (1997), U.S. Pat. No. 6,293,231 to Valentin (2001), U.S. Pat. No. 7,011,051 to the same inventor Epshteyn (2006), U.S. patent application “Universal hybrid engine, compressor and pump and method of operation” Ser. No. 11/110,109 (filing date Apr. 20, 2005) to the same inventor Epshteyn, U.S. patent application “Monocylindrical hybrid two-cycle engine, compressor and pump, and method of operation” Ser. No. 11/373,793 (filing date Mar. 10, 2006) to the same inventor Epshteyn and U.S. patent application “Monocylindrical hybrid powertrain and method of operation” Ser. No. 11/637,577 (filing date Dec. 12, 2006) to the same inventor Epshteyn.

While these devices fulfill their respective, particular objective and requirements, the aforementioned patents do not describe the continuously variable displacement monocylindrical hybrids integrate powertrain and method of operation for providing compact design with superefficient functions, increased specific power while minimizing engine size and fuel consumption, and hybrids activating and deactivating jointly with total energy recuperation.

The modern powertrains has the following disadvantages:
(a) The monocylindrical hybrid powertrain do not provide entire range of the vehicle engine power control by continuous alteration engine displacement.
(b) The monocylindrical hybrid engine, compressor and pump displacement alteration range is insufficient to keep the minimum specific fuel consumption of the entire range of the vehicle engine power change.
(c) The monocylindrical hybrid engine, compressor and pump displacement alteration range is insufficient for providing constant mean effective pressure of the engine during entire range of the vehicle engine power change.
(d) The monocylindrical hybrid powertrain do not utilize the total energy recuperation process.
(e) The monocylindrical hybrid powertrain do not achieve the acceleration magnitude of standard car and simultaneously utilize considerable smaller engine size.
(f) The monocylindrical hybrid powertrain do not utilize the maximum potential of it extremely small size.
(g) The monocylindrical hybrid hydraulic system of the engine and compressor pistons return stroke is complicated and expensive.
(h) The monocylindrical hybrid do not prevent side forces causes the pump plunger and axial rod interaction with inclined lever.
(i) The monocylindrical hybrid do not utilize the potential possibility of extremely high balancing quality of the engine and compressor pistons.

### BACKGROUND OF THE INVENTION

### Objects and Advantages

Therefore, it can be appreciated that there exists a continuing need for a new and improved super efficient hydraulic hybrid powertrain providing joint operation of the two monocylindrical hybrids having different maximum displacement and recuperation system having better specific data, lesser size and cost than widespread automotive engine and automatic transmission.

The present invention substantially fulfills these needs.

The objectives and advantages of the present invention are:
(a) To provide super efficient hybrid powertrain operation of entire range of the vehicle engine power by utilization two different size hybrids engine having continuously alteration displacement and activating and deactivating greater monocylindrical hybrid.
(b) To provide minimal specific fuel consumption and extremely low emission of entire range of engines power by monocylindrical hybrid engines having continuously variable displacement magnitude proportional to engines fuel supply per cycle.
(c) To provide constant engines load, mean effective pressure and maximal thermal efficiency during entire range of engines power by permanent fluid pressure of the hybrid pump outlet, load stabilizer and hydraulic motor inlet.
(d) To provide super efficient operation and extremely small size of the monocylindrical hybrid powertrain by utilization of the total energy recuperation which includes regenerative acceleration and regenerative braking.
(e) To preserve standard vehicle acceleration magnitude by a considerable smaller size engine associated with total energy recuperating motor and vehicle wheels by differential gear.
(f) To install the driver seat at the vehicle's fore for better viewing and to arrange seven passenger seats instead of five to increase interior car space without changing overall width and length of a standard car by arranging monocylindrical hybrid engines on one side of the vehicle.
(g) To provide simple and inexpensive system of the engine and compressor pistons return stroke by double-sided mechanical tie for axial rods.
(h) To provide the pump plunger and axial rod motion without side forces within rotor by lever interaction with rotor guiding grooves.
(i) To provide extremely high-quality balancing engine and compressor pistons movement without side forces by counterweight interaction with rotor guiding.

### SUMMARY OF THE INVENTION

In accordance with the present invention, the superefficient hydraulic hybrid powertrain, (which we shall refer simply as “hybrid powertrain”) of the vehicle is comprised of at least two different size monocylindrical hybrids engine, compressor and pump forming prime mover. Hybrids have electrohydraulic controllers of displacement volume by swash plate incline angle alteration. Hybrid pumps are coupled in parallel with load stabilizer and hydraulic motor. The hybrids parallel connection enables to activate and deactivate greater size hybrid. Hydraulic motor with variable displacement by differential gear coupled with energy recuperating motor having also variable displacement and coupled with a vehicle wheels. The recuperating motor and energy storage association forms second mover. The differential gear's ring gear is connected to the hydraulic motor shaft, sun gear is connected to the recuperating motor shaft and gear of the planet carrier is mechanically coupled with a vehicle wheels.

Each hybrid is comprised of synchronize mechanism, chain drive, conic reducer, swash plate with turn and shift systems, replenishing and electric hydraulic control system with valves and load stabilizer, recuperating motor associated with energy storage.

The hybrid engine is a two-cycle engine comprised of a cylinder with cooling system, piston with rings, cylinder head with combustion chamber, camshaft, air injection valve and exhaust valve. The engine piston is located between the compressor chamber and combustion chamber.

The compressor is comprised of a piston with rings and the compressor chamber located within the engine cylinder between the engine and compressor pistons. The compressor piston fastened to a hub and counterweight. The compressor is comprised of an intake and output valves located on the side surface of engine cylinder. The output valve is coupled with the air injection valve of the engine by a receiver, which is comprised of a water jacket and is located on the side surface of engine cylinder. The compressor intake valve is connected with the one lobe by means of rod and rocker. The compressor output valve is connected with the second lobe and both lobes fastened to rotor.

The pump housing is the engine cylinder fastened to a valve plate. A rotor is comprised of a stabilizer motor pistons and plunger fastened to the engine piston. The plunger, rotor, compressor piston and hub located coaxially. The rotor is coupled with the engine cylinder by a bearing with a disc spring. The valve plate is comprised of a pump inlet and outlet slots, associated with the pump chamber canal and comprised of a stabilizer motor's inlet and outlet slots. The valve plate fastened to the hydraulic motor.

The rotor axis and replenishing system pump shaft axis located on one center line. Within the valve plate mounted a bearings and intermediate shaft connected the rotor, and replenishing pump shaft.

The synchronize mechanism comprises two axial rods coupled with the swash plate by shoes outside of the rotor and located diametrically opposite within rotor. The first axial rod pivotably coupled to the yoke by shoe, pivotably coupled to the lever, connected to the pump plunger by the assembled crossbar. The lever pivotably coupled with the rotor by sliders and axle and pivotably coupled with a crossbar by sliders. The second axial rod coupled to the counterweight, which pivotably coupled with compressor piston's hub and yoke by shoe, inside of the rotor. The yoke pivotably coupled with a floating support connected by pistons, springs and bearing with a suspension support located outside of said rotor. The suspension support pivotably coupled with swash plate by means of a rods and turning levers.

The chain drive first sprocket wheel fastened to rotor and associated by chain with a second sprocket wheel mounted by bearing and chain drive housing on the side surface of engine cylinder and connected with engine camshaft by intermediate shaft and conic reducer's first and second gearwheels. Opposite side of the engine camshaft comprises a pulley associated with cooling system pump by means of the belt. The accessory regular units (not illustrated)—electric system generator, steering pump, and air conditioning compressor also associated with the belt.

The swash plate associated with the pump's valve plate by swash plate turn system and swash plate shift system which is same for the smaller and greater hybrids. The swash plate turn system is comprised servo cylinder with piston. The swash plate pin pivotably coupled with servo cylinder piston by rod. The servo cylinder fastened to the valve plate.

The swash plate shift system is comprised of a servo cylinder with piston and lever. The swash plate pivotably coupled with servo cylinder piston by lever and hinge pin. The servo cylinder fastened to the valve plate and the lever pivotably coupled with the servo cylinder ledges and piston.

The swash plate turn hydraulic system is comprised of a continuous and feedback servo electrohydraulic controller with solenoids. A first and second lines of the distributor is connected with the servo cylinder, third line is coupled with the load stabilizer and the fourth line of the distributor is coupled with the tank.

The swash plate shift hydraulic system is comprised of a continuous and feedback servo hydraulic distributor with solenoids. A first and second lines of the distributor is connected with the servo cylinder, third line is coupled with the load stabilizer and the fourth line of the distributor is coupled with the tank.

The electric hydraulic control system is comprised of a first and second hydraulic distributors, valve, two-way valve and replenishing system.

The four-way first hydraulic distributor has a first line connected in parallel to hybrid pumps outlet and hydraulic motor inlet, a second line connected in parallel to hybrid pumps inlet, a third line coupled in parallel with the replenishing pump outlet and hybrid stabilizer motor outlets and fourth line coupled with the load stabilizer.

The three-way second hydraulic distributor has a first line connected in parallel to hybrid stabilizer motor inlets, second line coupled with the energy storage and third line connected to the load stabilizer.

The valve is a four-way valve with solenoids having a first line and second lines connected to recuperating motor, a third line coupled with a replenishing system and fourth line coupled with energy storage.

The two-way valve is a two-position valve by a first and second lines coupled respectively with the load stabilizer and energy storage.

The replenishing system comprises the replenishing pump connected in parallel to an accumulator and relief valve.

There has thus been outlined, rather broadly, some features of the invention in order that the detailed description thereof that follows may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description illustrated in the drawings. The invention is capable of other embodiments and of being practiced and carried out in various ways. Also, it is to be understood that the Patent phraseology and terminology employed herein are for the purpose of description and should not be regarded is limiting.

As such, those skilled in the art will appreciate that the conception, upon which this disclosure is based, may readily be utilized as a basis for the designing of other structures, methods and system for carrying out the several purposes of the present invention. It is important, therefore, that the claims be regarded as including such equivalent constructions insofar as they do not depart from the spirit and scope of the present invention.

It is therefore an object of the present invention to provide a new and improved hybrid powertrain, which has all the advantages of the prior art systems engine, pump and hydraulic motor and none of the disadvantages.

It is another object of the present invention to provide a new and improved hybrid, which may be easy and efficiency manufactured and low price marketed.

It is an object of the present invention to provide decrease in weight and installation space of the hydrostatic hybrid powertrain with total energy recuperation.

It is a further object of the present invention is to provide a less operation cost of the hybrid powertrain.

An even further object of the present invention is to utilize regular accessory systems for the engine and hydrostatic transmission, which will reduce the price.

Lastly it is an object of the present invention to provide a new and super efficient hybrid powertrain with extremely low pollution emission, while minimizing the installation space and cost necessary in particular for an automobile.

In accordance with the present invention, the super efficient hydraulic hybrid powertrain, (which we shall refer simply as “hybrid powertrain”) of the vehicle is comprised of at least two different size monocylindrical hybrids engine, compressor and pump forming prime mover. Hybrids have electrohydraulic controllers of displacement volume by swash plate incline angle alteration. Hybrid pumps are coupled in parallel with load stabilizer and hydraulic motor. This hybrids parallel connection enables to activate and deactivate greater size hybrid. Hydraulic motor with variable displacement by differential gear coupled with energy recuperating motor having also variable displacement and coupled with a vehicle wheels. The recuperating motor and energy storage association forms second mover. The differential gear's ring gear is connected to the hydraulic motor shaft, sun gear is connected to the recuperating motor shaft and gear of the planet carrier is mechanically coupled with a vehicle wheels.

Each hybrid comprises synchronize mechanism, chain drive, conic reducer, swash plate with turn and shift systems, replenishing and electric hydraulic control system with valves and load stabilizer, recuperating motor associated with energy storage.

The hybrid engine is two-cycle engine comprised of a cylinder with cooling system, piston with rings, cylinder head with combustion chamber, camshaft, air injection valve and exhaust valve. The engine piston located between the compressor chamber and combustion chamber.

The compressor comprised of a piston with rings and the compressor chamber located within the engine cylinder between the engine and compressor pistons. The compressor piston fastened to a hub and counterweight. The compressor is comprised of an intake and output valves located on the side surface of engine cylinder. The output valve is coupled with the air injection valve of the engine by a receiver, which is comprised of a water jacket and is located on the side surface of engine cylinder. The compressor intake valve is connected with the one lobe by means of rod and rocker. The compressor output valve is connected with the second lobe and both lobes fastened to rotor.

The pump housing is the engine cylinder fastened to a valve plate. A rotor is comprised stabilizer motor pistons and plunger fastened to the engine piston. The plunger, rotor, compressor piston and hub located coaxially. The rotor is coupled with the engine cylinder by a bearing with a disc spring. The valve plate is comprised a pump inlet and outlet slots associated with the pump chamber canal and comprised stabilizer motor's inlet and outlet slots. The valve plate fastened to the hydraulic motor.

The synchronize mechanism comprises two axial rods coupled with the swash plate by shoes outside of the rotor and located diametrically opposite within rotor. The first axial rod pivotably coupled to the yoke by shoe, pivotably coupled to the lever, connected to the pump plunger by the assembled crossbar. The lever pivotably coupled with the rotor by sliders and axle and pivotably coupled with a crossbar by sliders. The second axial rod coupled to the counterweight, which pivotably coupled with compressor piston's hub and yoke by shoe, inside of the rotor. The yoke pivotably coupled with a floating support connected by pistons, springs and bearing with a suspension support located outside of said rotor. The suspension support pivotably coupled with swash plate by means of a rods and turning levers.

The chain drive first sprocket wheel fastened to rotor and associated by chain with a second sprocket wheel mounted by bearing and chain drive housing on the side surface of engine cylinder and connected with engine camshaft by intermediate shaft and conic reducer's first and second gearwheels. Opposite side of the engine camshaft comprises a pulley associated with cooling system pump by means of the belt. The accessory regular units (not illustrated)—electric system generator, steering pump and air conditioning compressor also associated with the belt.

The swash plate associated with the pump's valve plate by swash plate turn system and swash plate shift system which is same for the smaller and greater hybrids.

The swash plate turn system is comprised servo cylinder with piston. The swash plate pin pivotably coupled with servo cylinder piston by rod. The servo cylinder fastened to the valve plate.

The swash plate shift system is comprised of a servo cylinder with piston and lever. The swash plate pivotably coupled with servo cylinder piston by lever and hinge pin. The servo cylinder fastened to the valve plate and the lever pivotably coupled with the servo cylinder ledges and piston.

The swash plate turn hydraulic system is comprised of a continuous and feedback servo electrohydraulic controller with solenoids. A first and second lines of the distributor is connected with the servo cylinder, third line is coupled with the load stabilizer and the fourth line of the distributor is coupled with the tank.

The swash plate shift hydraulic system is comprised of a continuous and feedback servo hydraulic distributor with solenoids. A first and second lines of the distributor is connected with the servo cylinder, third line is coupled with the load stabilizer and the fourth line of the distributor is coupled with the tank.

The electric hydraulic control system is comprised of a first and second hydraulic distributors, valve, two-way valve and replenishing system.

The four-way first hydraulic distributor has a first line connected in parallel to hybrid pumps outlet and hydraulic motor inlet, a second line connected in parallel to hybrid pumps inlet, a third line coupled in parallel with the replenishing pump outlet and hybrid stabilizer motor outlets and fourth line coupled with the load stabilizer.

The three-way second hydraulic distributor has a first line connected in parallel to hybrid stabilizer motor inlets, second line coupled with the energy storage and third line connected to the load stabilizer.

The valve is a four-way valve with solenoids having a first line and second lines connected to recuperating motor, a third line coupled with a replenishing system and fourth line coupled with energy storage.

The two-way valve is a two-position valve by a first and second lines coupled respectively with the load stabilizer and energy storage.

The replenishing system comprises the replenishing pump connected in parallel to an accumulator and relief valve.

### DRAWINGS

### Figures

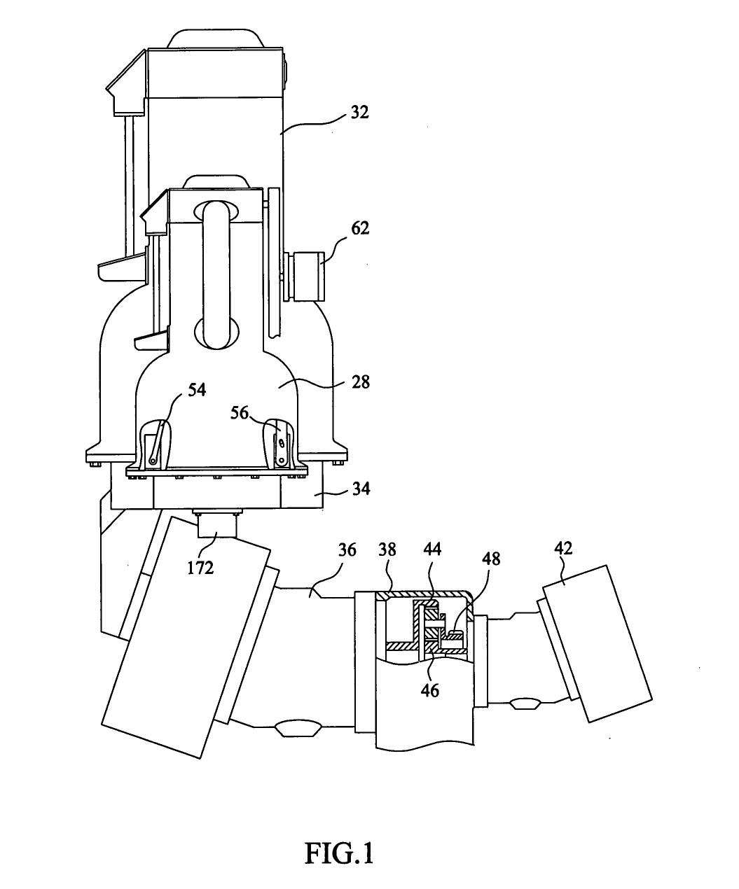

FIG. 1 shows a preferred embodiment of the superefficient hydraulic hybrid powertrain in accordance with the principles of the present invention.

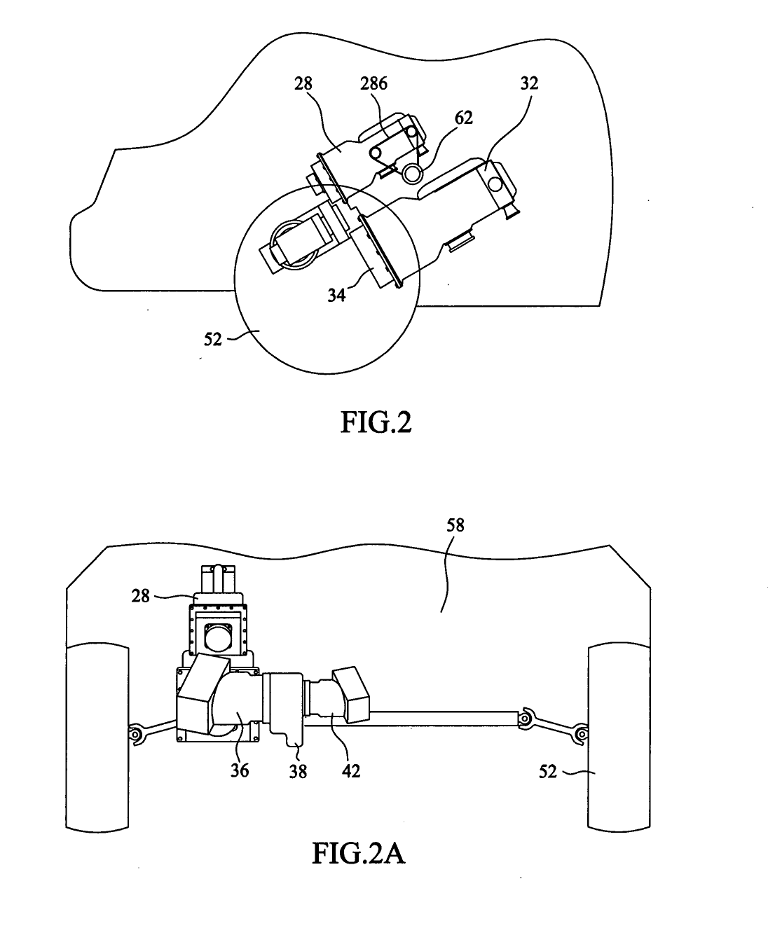

FIG. 2 is a side view of a vehicle equipped with a hybrid powertrain in accordance with the present invention.

FIG. 2A is a front view of a vehicle equipped with a hybrid powertrain in accordance with the present invention.

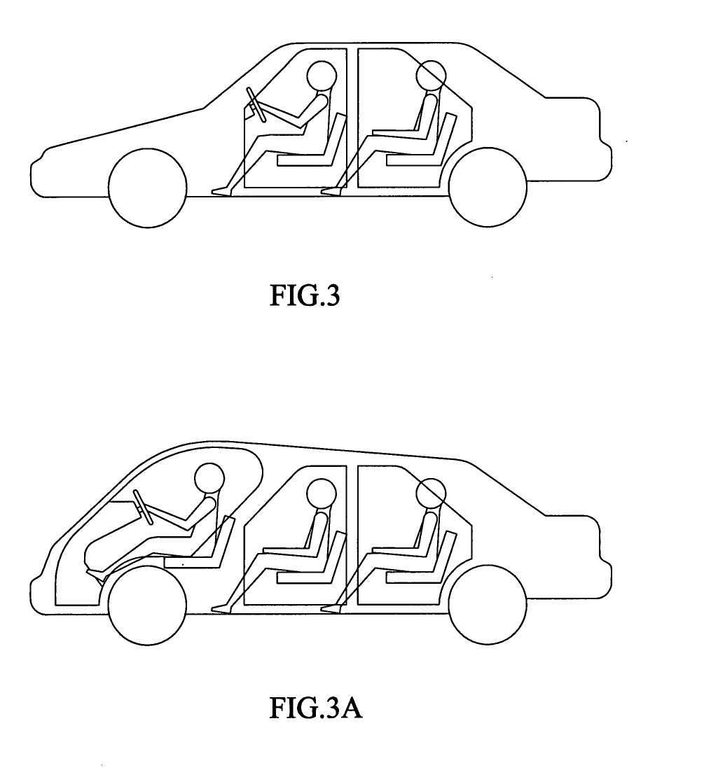

FIG. 3 is a schematic diagram of a prior art conventional five seat car.

FIG. 3A is a schematic diagram of a seven seat car equipped with a hybrid powertrain in accordance with the present invention.

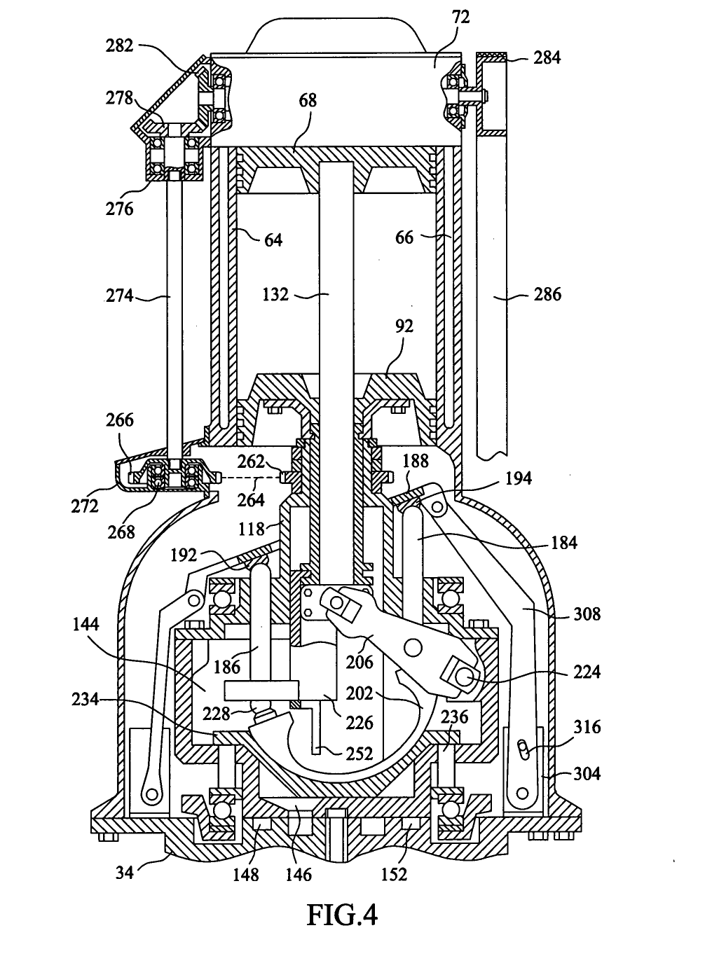

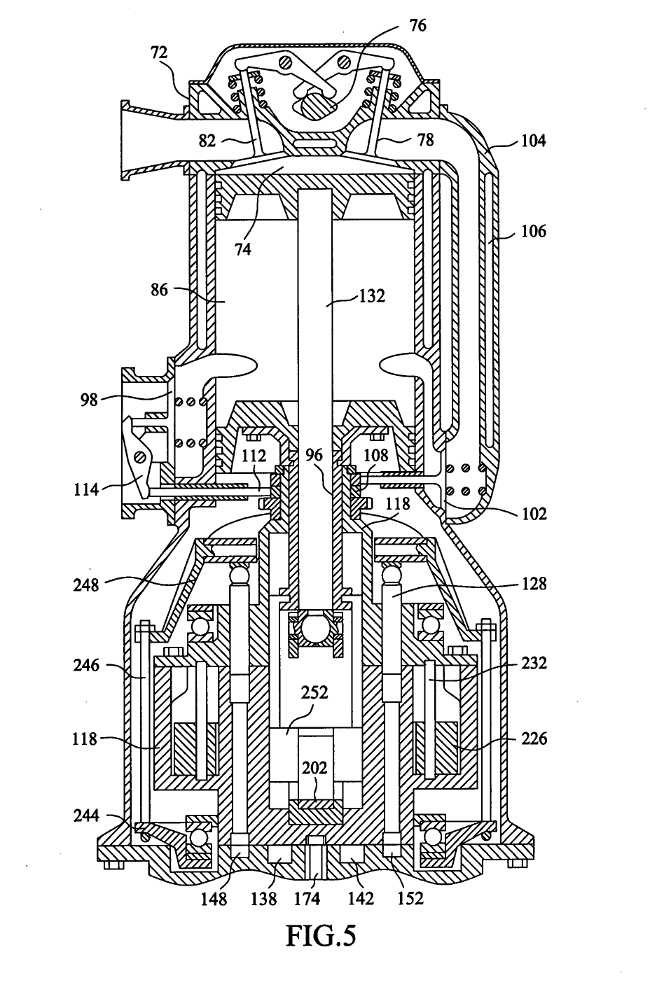

FIG. 4 shows a section along the engine cylinder axis and axial rods axis in accordance with the present invention.

FIG. 5 shows a section along the engine cylinder axis and engine and compressor valves in accordance with the present invention.

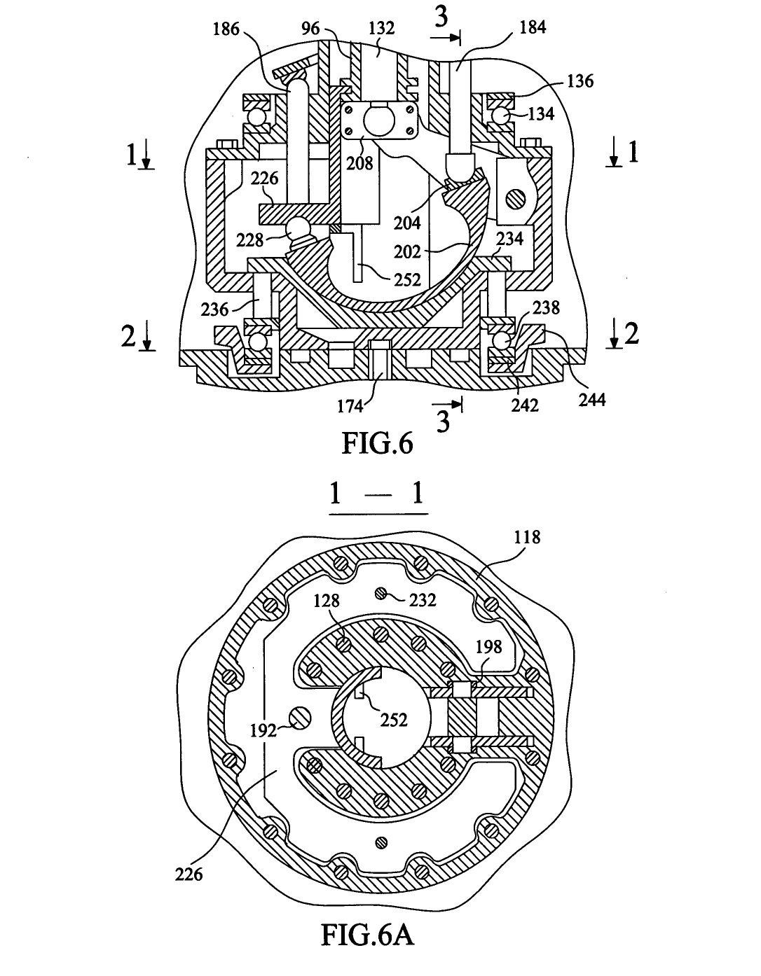

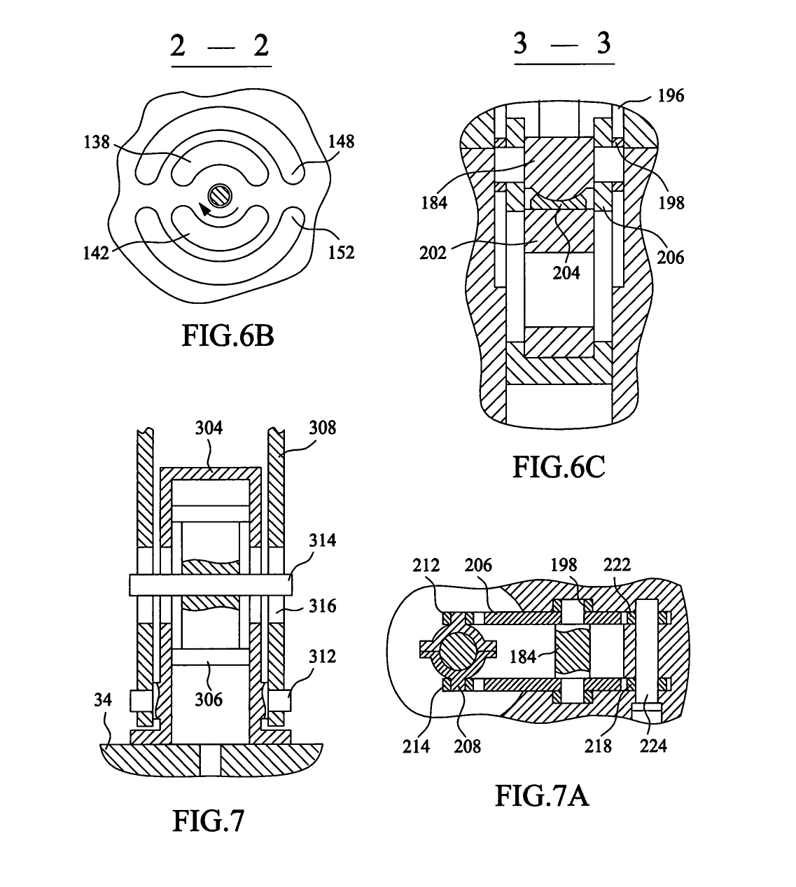

FIG. 6 shows a section in detail along the axial rods axis of the present invention.

FIG. 6A is a view in detail of the portion indicated by the section lines 1-1 in FIG. 6.

FIG. 6B is a view in detail of the portion indicated by the section lines 2-2 in FIG. 6.

FIG. 6C is a view in detail of the portion indicated by the section lines 3-3 in FIG. 6.

FIG. 7 shows a section along the servo cylinder axis of the swash plate shift system in accordance with the present invention.

FIG. 7A shows a section along the lever of the synchronize mechanism of the present invention.

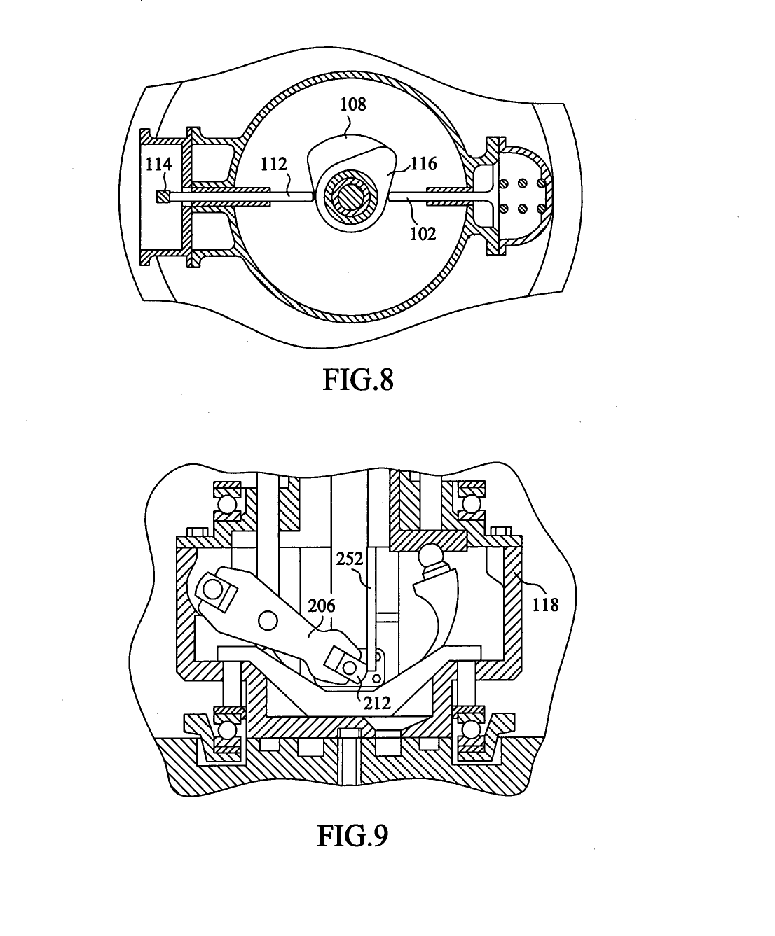

FIG. 8 shows a cross section of the engine cylinder along the compressor output valve in accordance with the present invention.

FIG. 9 shows a section along the engine cylinder axis and axial rods axis when the engine piston and pump plunger locates in the bottom end position in accordance with the present invention.

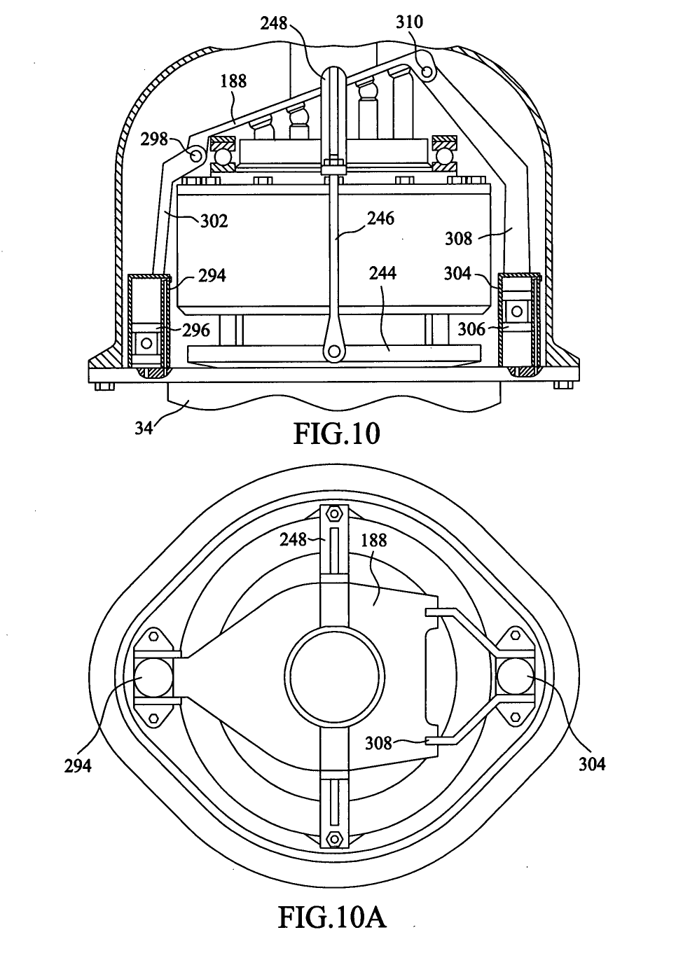

FIG. 10 is a front view of the swash plate turn and swash plate shift systems and connection of the swash plate with suspension support of the present invention.

FIG. 10A is a plan of the swash plate turn and swash plate shift systems and connection of the swash plate with suspension support in accordance with the present invention.

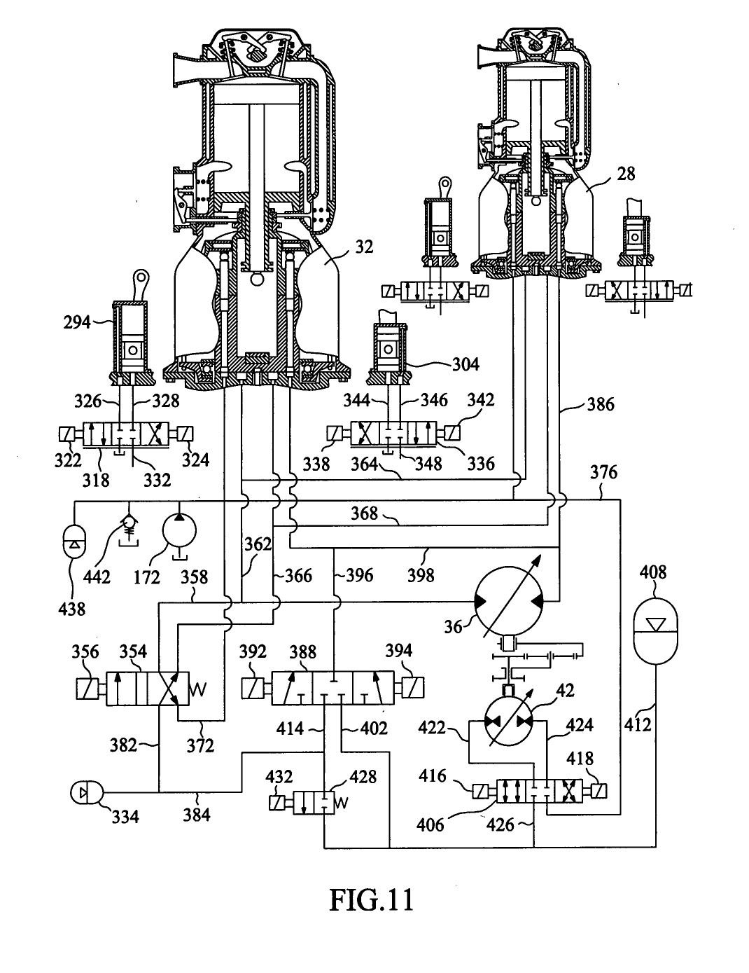

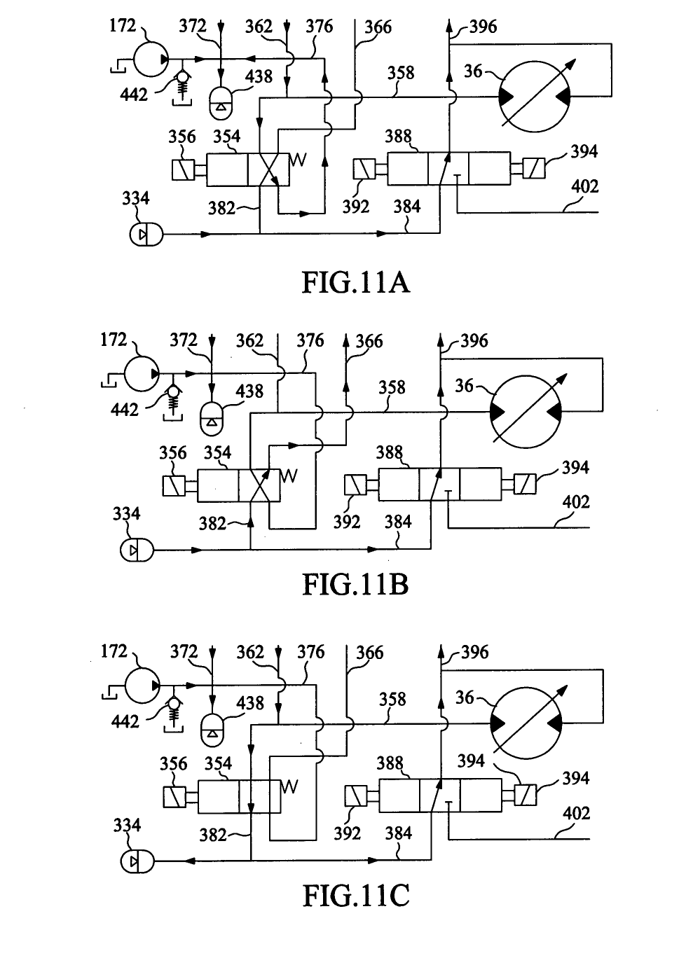

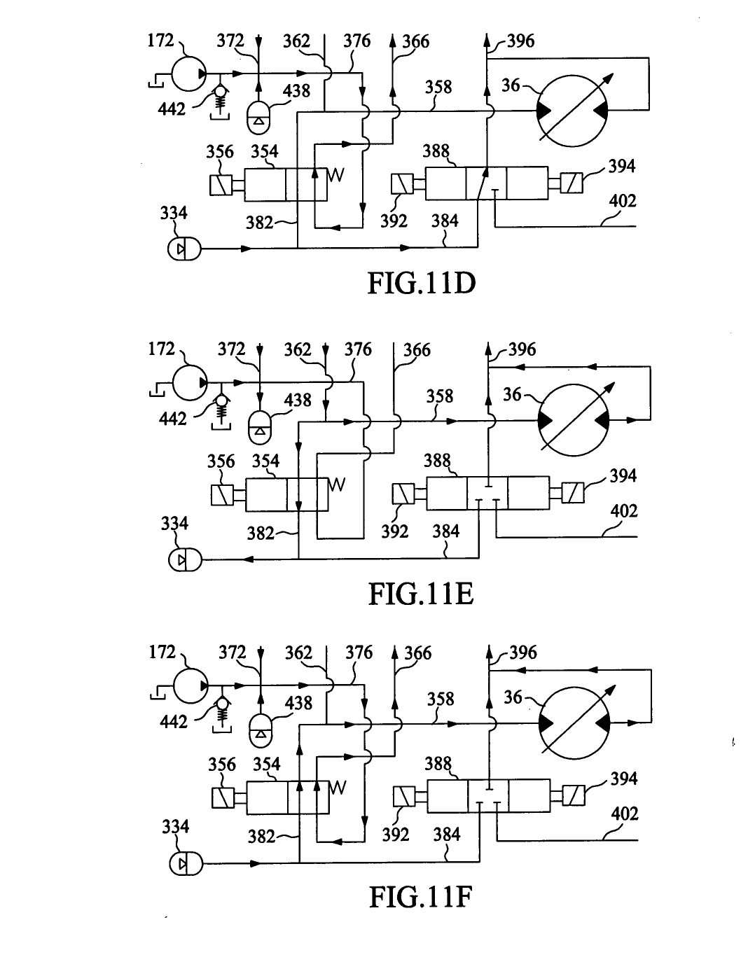

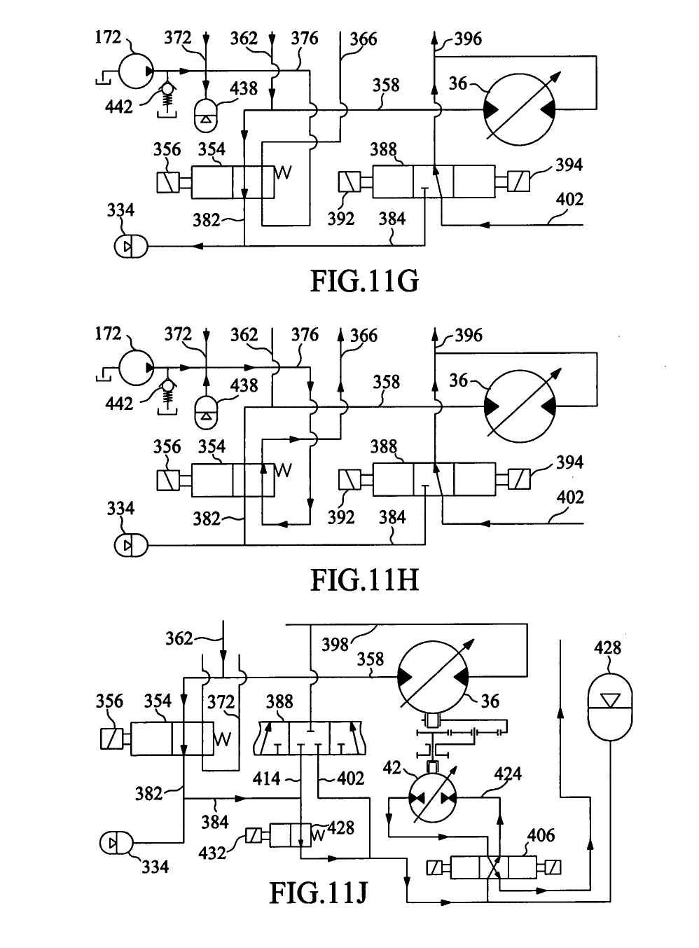

FIG. 11 shows a hydraulic diagram in accordance with the present invention.

FIGS. 11A and 11B show a fluid flow diagram of the engine start respectively during the engine piston downwards and upwards movement in accordance with the present invention.

FIGS. 11C and 11D show a fluid flow diagram of the engine idling respectively during the engine piston downwards and upwards movement in accordance with the present invention.

FIGS. 11E and 11F show a fluid flow diagram of the engine work operation respectively during the engine piston downwards and upwards movement in accordance with the present invention.

FIGS. 11G and 11H show a fluid flow diagram of the load stabilizer charge by means of the engine power operation respectively during the engine piston downwards and upwards movement in accordance with the present invention.

FIG. 11J shows a fluid flow diagram of the vehicle reverse in accordance with the present invention.

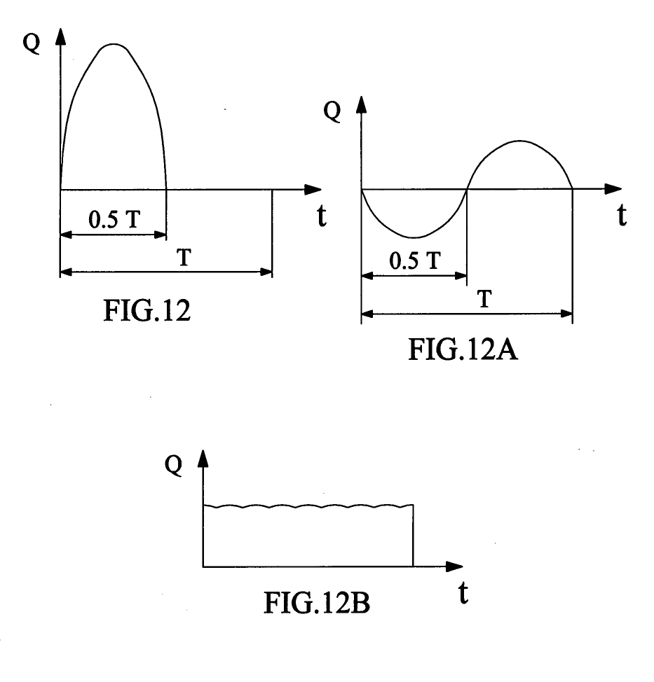

FIG. 12 is a diagram illustrating the pump supply during one cycle of the engine operation in accordance with the present invention.

FIG. 12A is a diagram illustrating of the load stabilizer fluid flow during one cycle of the engine operation in accordance with the present invention.

FIG. 12B is a diagram illustrating the uniform fluid flow via hydraulic motor in accordance with the present invention.

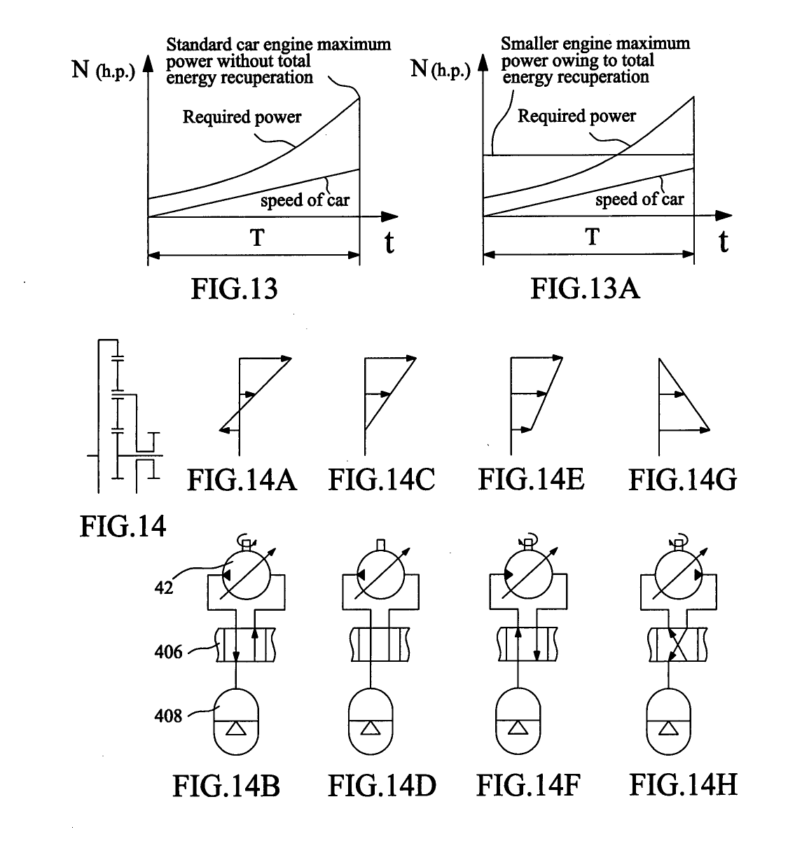

FIG. 13 are graphs of the prior art standard car speed and engine maximum power.

FIG. 13A are graphs of the car the same speed and engine smaller size and smaller maximum power by comparison with standard car owing to total energy recuperation in accordance with the present invention.

FIG. 14 shows a differential gear kinematical diagram of the present invention.

FIGS. 14A and 14B show respectively a kinematical diagram of the differential gear and a hydraulic diagram during the car initial acceleration range with energy storage charge in accordance with the present invention.

FIGS. 14C and 14D show respectively a kinematical diagram of the differential gear and a hydraulic diagram when the energy storage fluid pressure achieves maximum and sun gear stopped in accordance with the present invention.

FIGS. 14E and 14F show respectively a kinematical diagram of the differential gear and a hydraulic diagram during the car final acceleration range with energy storage discharge in accordance with the present invention.

FIGS. 14G and 14H show respectively a kinematical diagram of the differential gear and a hydraulic diagram during the car regenerative breaking, which simultaneously the energy storage charge and form the stand-by energy in accordance with the present invention.

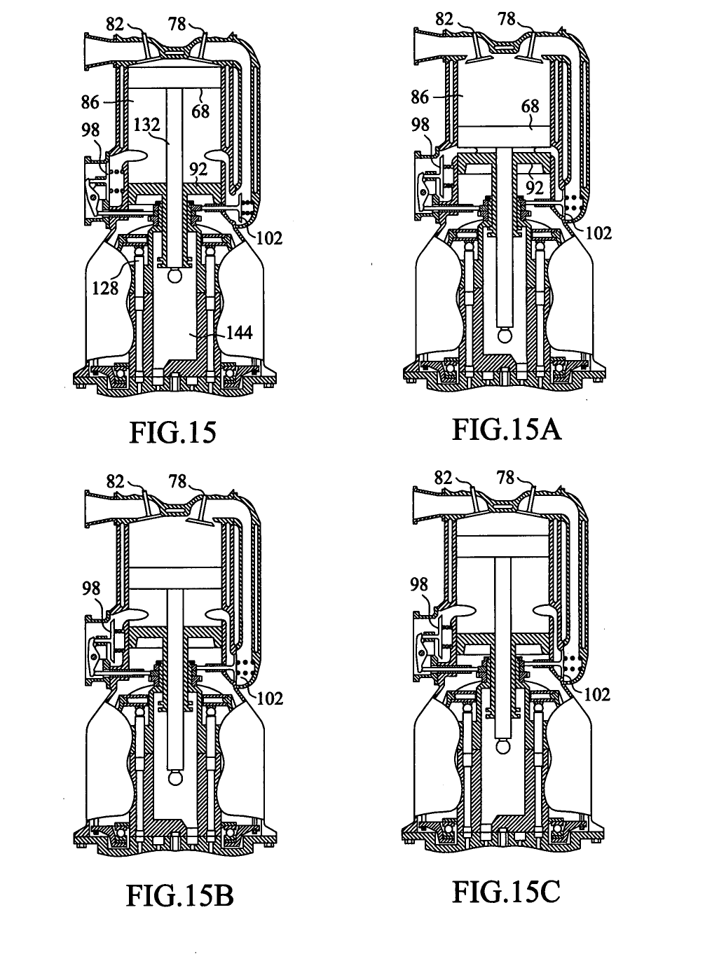

FIGS. 15 to 15C show an operating sequence of the monocylindrical hybrid engine, compressor and pump in accordance with the present invention.

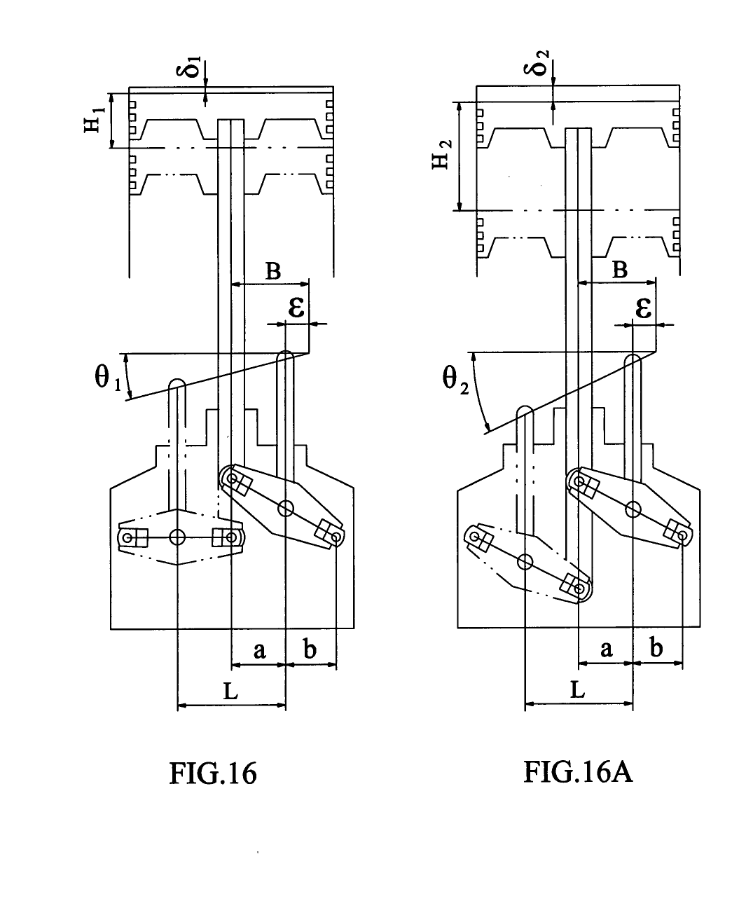

FIGS. 16 and 16A show respectively a kinematical diagram of the hybrid engine minimum and maximum displacement volume in accordance with the present invention.

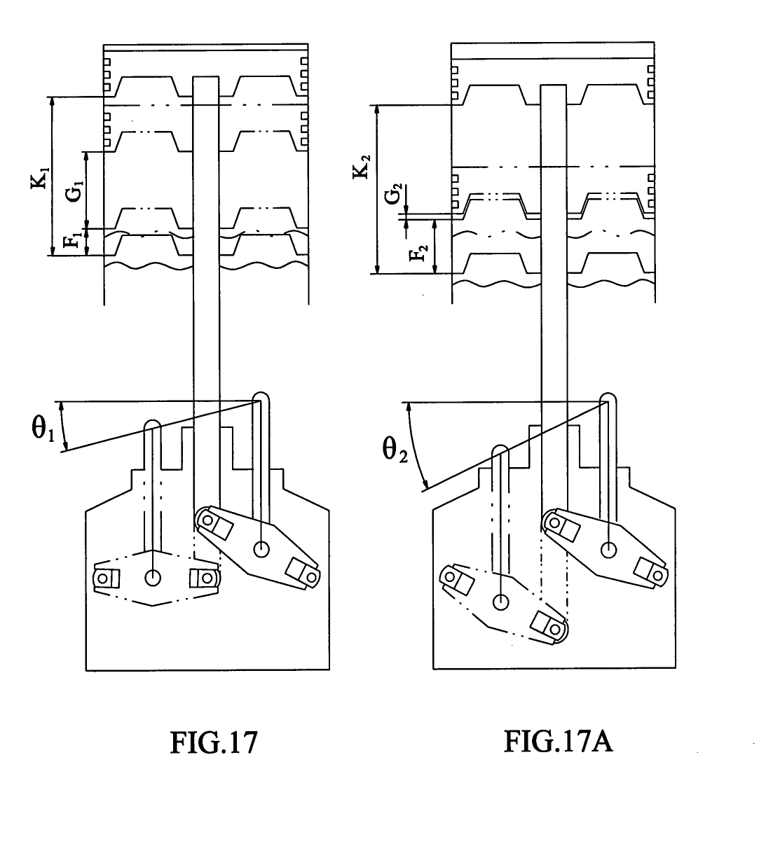

FIGS. 17 and 17A show respectively a kinematical diagram of the hybrid engine, compressor and pump minimum and maximum displacement volume in accordance with the present invention

The same reference numerals refer to the same parts through the various figures.

Arrow located on FIG. 6B show the direction of rotor rotation.

Arrows located on hydraulic lines (FIG. 11A-FIG. 11J) show the fluid flow direction in accordance with the hydraulic diagram on FIG. 11.

Arrows located on FIG. 14A, FIG. 14C, FIG. 14E, FIG. 14G show the gears linear velocity direction in accordance with the differential gear diagram on FIG. 14.

Arrows located on FIG. 14B, FIG. 14F, FIG. 14H show the direction of the recuperating motor shaft rotation and the fluid flow direction via the recuperating motor.

### DRAWINGS

### Reference Numerals

| | | | |
|---|---|---|---|
| 28 | smaller size monocylindrical hybrid | 32 | greater size monocylindrical hybrid |
| 34 | valve plate | 36 | hydraulic motor |
| 38 | differential gear | 42 | recuperating motor |
| 44 | ring gear of differential gear | 46 | sun gear of differential gear |
| 48 | gear of planet carrier | 52 | wheel of vehicle |
| 54 | swash plate turn system | 56 | swash plate shift system |
| 58 | free space under engine hood | 62 | pump of engines cooling system |
| 64 | cylinder of engine | 66 | cooling system of engines |
| 68 | engine piston | 72 | engine cylinder head |
| 74 | combustion chamber | 76 | engine camshaft |
| 78 | air injection valve | 82 | exhaust valve |
| 86 | compressor chamber | 92 | compressor piston |
| 96 | hub | 98 | intake valve of compressor |
| 102 | output valve of compressor | 104 | receiver |
| 106 | water jacket of receiver | 108 | lobe of compressor intake valve |
| 112 | rod | 114 | rocker |
| 116 | lobe of compressor output valve | 118 | rotor |
| 128 | piston of stabilizer motor | 132 | plunger of pump |
| 134 | bearing of rotor | 136 | disc spring |
| 138, 142 | slots of pump | 144 | pump chamber |
| 146 | canal of pump chamber | 148, 152 | slots of stabilizer motor |
| 172 | replenishing pump | 174 | shaft |
| 184, 186 | axial rods | 188 | swash plate |
| 192, 194 | shoes of axial rods | 196 | rotor guiding groove |
| 198 | slider | 202 | yoke |
| 204 | shoe | 206 | lever |
| 208 | crossbar | 212, 214, 218, 222 | sliders |
| 224 | axle | 226 | counterweight |
| 228 | shoe | 232 | guiding of rotor |
| 234 | floating support | 236 | piston of suspension support |
| 238 | bearing of suspension support | 242 | spring of suspension support |
| 244 | suspension support | 246 | rod of suspension support |
| 248 | turning lever of swash plate | 252 | stay |
| 262 | sprocket wheel | 264 | chain |
| 266 | sprocket wheel | 268 | bearing |
| 272 | chain drive housing | 274 | intermediate shaft |
| 276 | conic reducer | 278, 282 | gearwheels of conic reducer |
| 284 | pulley | 286 | belt |
| 294 | servo cylinder | 296 | piston of servo cylinder |
| 298 | pin of swash plate | 302 | rod |
| 304 | servo cylinder | 306 | piston of servo cylinder |
| 308 | lever | 310 | hinge pin of swash plate |
| 312 | ledge of servo cylinder | 314 | axle |
| 316 | groove | 318 | electrohydraulic controller |
| 322, 324 | solenoids | 326, 328, 332 | hydraulic lines |
| 334 | load stabilizer | 336 | electrohydraulic controller |
| 338, 342 | solenoids | 344, 346, 348 | hydraulic lines |
| 354 | hydraulic distributor | 356 | solenoid |
| 358, 362, 364, 366, 368 | hydraulic lines | 372, 376, 382, 384, 386 | hydraulic lines |
| 388 | hydraulic distributor | 392, 394 | solenoids |
| 396, 398, 402 | hydraulic lines | 406 | valve |
| 408 | energy storage | 412, 414 | hydraulic lines |
| 416, 418 | solenoids | 422, 424, 426 | hydraulic lines |
| 428 | two-way valve | 432 | solenoid |
| 438 | accumulator of replenishing system | 442 | relief valve |

### DETAILED DESCRIPTION

With reference now to the drawings, and in particular, to FIGS. 1 through 17A thereof, the preferred embodiment of the new and improved hybrid powertrain embodying the principles and concepts of the present invention will be described.

Specifically, it will be noted in the various Figures that the device relates to a hybrid powertrain of vehicle for providing a new and superefficient hybrid powertrain with extremely low pollution emission, while minimizing the installation space and cost necessary in particular for an automobile.

In accordance with the present invention the superefficient hydraulic hybrid powertrain, (which we shall refer to simply as “hybrid powertrain”) of vehicle comprises at least two different maximum displacement monocylindrical hybrids engine, compressor and pump forming prime mover. Pumps coupled in parallel with load stabilizer and hydraulic motor, which by differential gear coupled with recuperating motor. Each hybrid comprises synchronize mechanism, chain drive, conic reducer, swash plate with turn and shift systems, replenishing and electric hydraulic control system with valves and load stabilizer, recuperating motor associated with energy storage.

The smaller size monocylindrical hybrid 28 (FIG. 1) and greater size monocylindrical hybrid 32 of the hybrid powertrain by valve plate 34 coupled with hydraulic motor 36, which by differential gear 38 coupled with recuperating motor 42. Differential gear's ring gear 44 connected to the hydraulic motor 36 shaft, sun gear 46 connected to the recuperating motor 42 shaft and gear 48 of the planet carrier mechanically coupled with said vehicle wheels 52 (FIG. 2). Each hybrid comprises swash plate turn system 54 and swash plate shift system 56.

Hybrids arrangement on the vehicle provides free space 58 (FIG. 2A) under engine hood. The smaller size monocylindrical hybrid 28 (FIG. 1) comprises cooling system pump 62.

Each monocylindrical hybrid two-cycle engine comprised of a cylinder 64 (FIG. 4) with cooling system 66, piston 68, cylinder head 72 with combustion chamber 74 (FIG. 5), camshaft 76, air injection valve 78 and exhaust valve 82. The engine piston located between the combustion chamber 74 and compressor chamber 86.

The compressor is comprised of a piston 92 (FIG. 4) and the compressor chamber 86 located within the engine cylinder between the engine and compressor pistons. The compressor piston fastened to a hub 96 (FIG. 5) and compressor is comprised of an intake 98 and output 102 valves, which are located on the side surface of engine cylinder. The output valve 102 coupled with the engine air injection valve by a receiver 104, which is comprised of a water jacket 106 and is located on the side surface of engine cylinder. The compressor intake valve is connected with the one lobe 108 (FIG. 5, FIG. 8) by means of rod 112 and pivotably mounted rocker 114. The compressor output valve is connected with the second lobe 116 (FIG. 8) and both lobes fastened to pump's rotor 118 (FIG. 4, FIG. 5).

The pump housing is the engine cylinder fastened to a valve plate 34 (FIG. 1, FIG. 4). A pump's rotor 118 is comprised stabilizer motor pistons 128 (FIG. 5, FIG. 6A) and plunger 132 fastened to the engine piston. The plunger, rotor, compressor piston and hub located coaxially. The rotor is coupled with the engine cylinder by a bearing 134 (FIG. 6) with a disc spring 136. The valve plate is comprised a pump inlet and outlet slots 138, 142 (FIG. 5, FIG. 6B), associated with the pump chamber 144 (FIG. 4) by canal 146 and comprised stabilizer motor's inlet and outlet slots 148, 152 (FIG. 4, FIG. 5, FIG. 6B). The rotor axis and replenishing pump 172 (FIG. 1) shaft axis located on one center line. Within the valve plate mounted shaft 174 (FIG. 5, FIG. 6) connected the rotor and replenishing pump shaft.

The synchronize mechanism comprises a two axial rods 184, 186 (FIG. 4, FIG. 6) coupled with swash plate 188 (FIG. 4) by shoes 192, 194 outside of the rotor and located diametrically opposite within rotor. The first axial rod 184 coupled with rotor guiding grooves 196 (FIG. 6C, FIG. 7) by sliders 198, pivotably coupled to the yoke 202 by shoe 204 (FIG. 6), pivotably coupled to the lever 206 (FIG. 7A), connected to the pump plunger by crossbar 208 and sliders 212, 214. The lever pivotably coupled with the rotor by sliders 218, 222 and axle 224. The second axial rod 186 (FIG. 4) coupled to the counterweight 226 which coupled with yoke by shoe 228, coupled with compressor piston's hub and mounted inside of the rotor by means of guiding 232 (FIG. 5 FIG. 6A). The yoke pivotably coupled with a floating support 234 (FIG. 6) connected by pistons 236, bearing 238 spring 242 with a suspension support 244 (FIG. 5, FIG. 10) located outside of rotor. The suspension support pivotably coupled with swash plate by means of rods 246 (FIG. 5, FIG. 10, FIG. 10A) and turning levers 248. Within rotor mounted a stay 252 (FIG. 4, FIG. 6).

The chain drive first sprocket wheel 262 (FIG. 4) fastened to rotor 118 and connected by chain 264 with a second sprocket wheel 266 mounted by bearings 268 and chain drive housing 272 on the side surface of engine cylinder and connected with engine camshaft by intermediate shaft 274 and conic reducer's 276 first and second gearwheels 278, 282. Opposite side of the engine camshaft comprises a pulley 284 associated with the belt 286. The belt actuated engines cooling system pump 62 (FIG. 1) and accessory regular units (not illustrated)—electric system generator, steering pump and air conditioning compressor.

A swash plate turn and shift systems of the smaller and greater hybrids is same.

The swash plate turn system is comprised servo cylinder 294 (FIG. 10, FIG. 10A) with piston 296. The swash plate 188 pin 298 pivotably coupled with servo cylinder piston 296 by rod 302. The servo cylinder fastened to the valve plate.

The swash plate shift system is comprised of a servo cylinder 304 (FIG. 4, FIG. 7, FIG. 10, FIG. 10A) with piston 306 and lever 308 pivotably coupled with hinge pin 310 of the swash plate. The lever coupled with ledges 312 of servo cylinder and coupled with piston's 306 axle 314 by grooves 316. The servo cylinder 304 fastened to the valve plate

The swash plate turn hydraulic system is comprised of a continuous and feedback servo electrohydraulic controller 318 (FIG. 11) with solenoids 322, 324. A first and second lines 326, 328 of the controller is connected with the servo cylinder 294, third line 332 is coupled with the load stabilizer 334 and the fourth line of the distributor is coupled with the tank.

The swash plate shift hydraulic system is comprised of a continuous and feedback servo electrohydraulic controller 336 with solenoids 338, 342. A first and second lines 344, 346 of the controller is connected with the servo cylinder 304, third line 348 is coupled with the load stabilizer and the fourth line of the distributor is coupled with the tank.

The electric hydraulic control system is comprised of a first and second hydraulic distributors, valve, two-way valve and replenishing system.

The four-way first hydraulic distributor 354 has a solenoid 356, first line 358 connected in parallel to hydraulic motor 36 inlet and hybrid pumps outlet by lines 362, 364, a second line 366 by line 368 connected in parallel to hybrid pumps inlet, a third line 372 by line 376 coupled in parallel with the replenishing pump 172 outlet and hybrid stabilizer motors outlets and fourth line 382 by line 384 coupled with the load stabilizer. The hydraulic motor 36 outlet coupled with hybrid stabilizer motors inlets by line 386.

The three-way second hydraulic distributor 388 has a solenoids 392, 394, first line 396 connected in parallel to hybrid stabilizer motors inlets and hydraulic motor 36 outlet by line 398, second line 402 coupled with valve 406 and energy storage 408 by line 412 third line 414 by line 384 connected to the load stabilizer 334.

The valve 406 is a four—way valve with solenoids 416, 418 having a first and second lines 422, 424 connected to recuperating motor 42, third line 376 coupled with a replenishing system and fourth line 426 by line 412 coupled with energy storage 408.

The two-way valve 428 is a two-position valve having solenoid 432 coupled by lines 414, 384 with load stabilizer and by line 412 with energy storage 408.

The replenishing system comprises the replenishing pump 172 connected in parallel to an accumulator 438 and relief valve 442.

The foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

### Description of Operation.

The hybrid powertrain super efficient operation provides the crucial factor—engines operation occurs with permanent load independent of the power alteration required by vehicle. Hybrid engines and pumps permanent load determines load stabilizer (LS), which is a standard pneumohydraulic accumulator with small fluid pressure change during engine cycle. Such a super efficient operation provided by continuously variable displacement volume of a two different size monocylindrical hybrids engine, compressor and pump. The greater size hybrid engine can be activated and deactivated respectively by switching on and switching off the fuel supply. This provides unique wide range of the hybrids displacement continuously alteration and enables to control entire range of engines power alteration without change of the engines mean effective pressure. The permanent engine load and engines continuously variable displacement volume proportional to the fuel supply per cycle defines extremely low specific fuel consumption. Re-use of energy utilizes two different modes of energy recuperation: the vehicle regenerative acceleration and the vehicle regenerative breaking. These two types of energy recuperation are the total energy recuperation process enables significant reduction of the prime mover size and simultaneously preserving acceleration magnitude of the standard car.

The vehicle hydraulic hybrid powertrain has starting, restarting, idling and work modes of operation, load stabilizer and energy storage charging by means of prime mover. Also, the hybrid powertrain provides the vehicle reverse movement.

The operator initiates the start. Switching from start to idle mode is automatic. The work mode is initiated automatically after the accelerator pedal (not illustrated) is depressed. Engine start.

The operator switches start by key ignition (not illustrated) and the solenoid 392 switches distributor 388 to the engine start (FIG. 11, FIG. 11A, FIG. 11B) position. During the starting process pressurized fluid goes from the LS 334 via distributor 354 and lines 382, 366 to the hybrid pumps inlet and via distributor 388 and lines 384, 414, 396 to the hybrid's stabilizer motor inlet. The pressurized fluid activates the stabilizer motor pistons 128 interacting with swash plate 188 and goes to the replenishing system accumulator 438 along line 376 from the stabilizer motor outlet independent of the engine piston direction motion.

During one half of rotor revolution, while the pump chamber canal 146 (FIG. 4) connects with the pump inlet slot 138 (FIG. 6B) the outlet slot is closed. During the second half of rotor revolution, while the pump chamber canal connects with the pump outlet slot, the inlet slot is closed. Such sequences occur in all of the operating modes.

So during the engine piston downwards motion (FIG. 11A) the stabilizer motor actuate hybrids motion using the LS energy.

During engine piston return stroke (FIG. 11B) the LS fluid supply actuates the stabilizer motor motion and simultaneously via line 366 actuated the pump plunger motion. Thus the pump plunger upward motion occurs in the capacity of linear hydraulic motor. The engine piston compresses the air in the combustion chamber, and conventional fuel injection (not illustrated) initiates the power stroke of the engine.

The stored LS energy provides of the monocylindrical engine start up by means of activating jointly the stabilizer motor (in capacity of the starter) and pump plunger during the engine piston upwards motion and activating the stabilizer motor during the engine piston downwards motion.

The rotor by chain drive and conic reducer activate the engine camshaft, which by means of the pulley with belt actuate cooling system standard pump and conventional accessory units: electric system generator, steering pump (not illustrated).

The starter is able to fast start and restart hybrid engine and capable of rapid activating of greater size hybrid engine. This process occurs during of smaller size hybrid engine operation. Such independent operation provides by supercharging of fluid from hybrid pumps to connecting in parallel hydraulic motor and load stabilizer. The high-power starter enables a quiet starting process to occur, and also enables an engine to shut down at every red traffic light with decreased fuel consumption. This is very valuable in particular for automobiles drive train.

### Idling Mode.

The rotor angular velocity increases after the start up. A rotor speed sensor (not illustrated) switches the solenoid 356 (FIG. 11, FIG. 11C, FIG. 11D) and the distributor 354 connects LS in parallel to the pump outlet and hydraulic motor 36 inlet by lines 382, 358, 362. The distributor 388 remains the engine start position. The engine automatically switches from starting mode to the idling mode. During the idling mode the hydraulic motor shaft is on brake, the greater hybrid is deactivated and the motion of smaller hybrid occurs with minimum displacement engine, compressor and pump and minimum cycles per min which provides extremely low fuel consumption. The hybrids have common cooling system. The cooling system pump 62 (FIG. 1) mounted on smaller hybrid preserves optimal temperature of the greater hybrid and provides optimal condition for fast activating of the greater hybrid engine. This is very valuable in particular for diesel engine.

During the engine piston downwards motion (FIG. 11C) the fluid goes from the pump outlet via the line 362 and the pump inlet line 366 is disconnected. During the engine piston upwards motion (FIG. 11D) the fluid goes via line 366 to the pump inlet and the pump outlet is disconnected.

The pump displacement volume equals the stabilizer motor displacement volume. During the half rotor revolution (the engine piston downwards motion, FIG. 11C) the pump supply equals the whole pump displacement volume but the stabilizer motor uses only half of the pump volume. Because the pump coupled in parallel with LS and stabilizer motor inlet by lines 362, 382, 358 the surplus of the pump fluid volume enter the LS. During the next half of rotor revolution (FIG. 11D the engine piston upwards motion) this surplus of fluid volume goes from the LS to the stabilizer motor inlet via lines 384 and 396.

So the engine piston return stroke provides the stabilizer motor used the LS energy and actuated the hybrid motion. The stabilizer motor actuated the hybrid motion independent of the engine piston direction movement.

The energy of combustion pressure is transmitted to the piston-plunger during its movement from the top end position (TEP) to the bottom end position (BEP). This process is illustrated in FIG. 15. The engine valves 78, 82 are closed. The compressor intake valve 98 is closed and the output valve 102 is open.

The counterweight 226 and hub 96 (FIG. 6) is actually a bearing because the compressor piston is not rotating. The crossbar 208 and plunger 132 is also actually a bearing because the pump plunger with engine piston is not rotating.

The synchronize mechanism axial rods 184, 186 (FIG. 4) interaction with swash plate 188 by shoes 192, 194 provides the opposite movement of engine and compressor pistons. The rotor drives the engine camshaft by sprocket wheels 262, 266, chain 264 and the conic reducer 276 gearwheels 278, 282 and simultaneously rotor rotates the lobes 108, 116 (FIG. 8) activating the compressor intake valve 98 (FIG. 5) by rod 112 and rocker 114 and output valve 102.

So the synchronize mechanism provides the engine and compressor valves with motion, with consequent performance in compliance with a two—stroke working cycle; and each engine piston stroke from TEP to BEP is a power stroke.

The movement of the synchronize mechanism components in oil within pump chamber provides high quality lubrication and increase the efficiency. The compressor piston and axial rod have equal strokes. The lever gives the piston-plunger an increased stroke, in accordance with the lever ratio.

The yoke rotates simultaneously about two different axes. One axis is the axis of the rotor. The other axis is the axis of the cylindrical surface floating support 202 (FIG. 4) which perpendicular to the rotor axis. The yoke rotates about the latter axis and provides a constant distance between the swash plate and the yoke's flat surface in the plane of the axial rod centerlines independent of the swash plate incline angle. Also this occurs irrespective of the magnitude or direction of the forces acting on the pistons or plunger.

Thus the opposing movement of the compressor and the engine pistons allows the space under the engine piston to function as chamber of the compressor. This ensures, that the noise is decreased, because static energy is used, that is air pressure, instead of air high speed, i.e. kinetic energy as in a conventional blower. Because the pistons are moving in opposing directions, the engine piston becomes in essence a compressor piston. This results in direct energy transmission for air compression, and provides increased efficiency.

The opposing movement provides simple and high-quality balancing of the system because the compressor piston jointly with the counterweight compensates for the inertial forces influencing the engine piston and pump plunger set. This considerably decreases the vibration and determines the stationary connection of the engine cylinders and hydraulic motor by valve plate. Such connection causes unique solid monoblock design of the hydrostatic transmission without pipes and hoses between pumps and motors.

The pistons' opposing movement provides a compressor displacement volume greater than the volume of the engine, because it is formed by the superposition of the motions of the engine and compressor pistons. This increases air mass intake and specific power of the engine. The idling mode continues as long as the accelerator pedal is not depressed.

### Work Mode.

The accelerator pedal (not illustrated) depression increases the rotor angular velocity and a speed sensor (not illustrated) switches off the solenoid 392 (FIG. 11, FIG. 11E, FIG. 11F). The distributor 388 switches to the neutral position and disconnect lines 384, 396, 402. The distributor 354 remains the engine idling position. Thus the hydraulic system automatically switches from idling to work mode if the accelerator pedal is depressed.

The FIGS. 15, 15A, 15B, 15C illustrate the hybrid operating sequence during a single revolution of the rotor.

The FIG. 15 shows the piston-plunger power stroke from TEP to BEP and simultaneously the compressor piston power stroke with motion in opposite directions. The engine valves 78, 82 are closed, the compressor output valve 102 is open and the intake valve 98 is closed. The pressurized fluid flow goes from the pump outlet via lines 362, 358 (FIG. 11, FIG. 11E) to the hydraulic motor 36 inlet and via lines 386, 398 to the stabilizer motor inlet. The pump and the stabilizer motor displacement volume equal. During the half cycle the pump supply is equal the pump displacement volume but the stabilizer motor intake is only half of the pump volume because the pump and stabilizer motor coupled in series. The fluid volume surplus via distributor 354 and line 382 entered the LS 334. During the next half cycle (FIG. 11F) of the engine piston upwards motion this fluid volume surplus entered the motor 36 inlet from the LS via lines 382, 358 and distributor 354. Diagrams in figures FIG. 12, FIG. 12A, FIG. 12B show this process. The T is one cycle time. The Q (FIG. 12) is supply of pump during half cycle time, the LS (FIG. 12A) half cycle time receives fluid from the pump and next half cycle time delivers fluid to the hydraulic motor. The uniform fluid flow via hydraulic motor (FIG. 12B) occurs independent of the pump fluid flow pulsation due the LS operation in the stabilizer mode. The hydraulic motor outlet coupled with stabilizer motor inlet form closed-loop hydrostatic drive, which provides braking for overrunning loads such as a vehicle rolling down hill.

During return stroke of the engine piston the fluid goes from hydraulic replenishing system via lines 376, 366 (FIG. 11F) and distributor 354 to the pump inlet and provides necessary suction fluid pressure for return stroke of the engine piston. This is how occurs the transformation of the single pump plunger supply pulsation into uniform fluid flow feeding hydraulic motor during the engine power operation. So the hydraulic motor connection in series with the stabilizer motor and connection in parallel with load stabilizer and pump determines the uniform fluid flow via hydraulic motor despite of the pump fluid flow pulsation.

Due to direct energy transmission the engine piston return stroke occurs with minimum energy loss and minimum specific fuel consumption. Also this decreases weight, cost and installation space of the hybrid.

The yoke, floating support and suspension support pivotably coupled with the swash plate forms double-sided tie for axial rods and by spring 242 (FIG. 6) provides permanent pushing axial rods against the swash plate and allows use of simple single cylinder hybrids instead of expensive, complicated and heavy multi-cylinder engine, compressor and a pump.

The energy of combustion pressure is transmitted to the piston-plunger during its movement from the TEP to the BEP during a half revolution of the rotor.

The greatest part of the power flow is the pump supply directly from the pump outlet to the hydraulic motor.

The pump plunger fixed to the engine piston provides direct energy transmission. This allows use of one simple unit hybrid instead of two complicated and heavy regular units (an engine and a pump). Also the hybrid solves the problem of using reciprocating engine and compressor without a crankshaft or connecting rods. This increases efficiency and decreases fuel consumption. The pump plunger disposition on the rotor's centerline allows a considerable increase of rotor speed rotation and transmission power in comparison with a conventional variable displacement pump.

All these factors enable us to increase the pump power to equal the maximum engine power.

The second, and much smaller, part of the power flow uses the interaction of the underside of the engine piston with the compressor piston to compress air. The compressor piston motion is provided by fluid pressure on the hub 96 (FIG. 6) in the pump chamber simultaneously with the pump power stroke, without side forces. The air compression with direct energy transmission by means of the fluid pressure increases efficiency and decreases fuel consumption. The additional cooling of air (intercooling) by the receiver water jacket 106 (FIG. 5) also increases the engine thermal efficiency and decreases fuel consumption.

The third and smallest part of the power flow is transmitted to an engine and compressor valves and accessory units.

The location of the piston-plunger inside the cylinder and simultaneously inside the hub 96 and the minimum magnitude of side forces as it moves, allow the engine piston length to be minimized. The location of the compressor piston and the hub simultaneously within the cylinder and the rotor allows the compressor piston length to be minimized. This provides a compact design, minimizes piston mass and forces of inertia.

The pump plunger and hub interaction without side forces from inclined lever provides interaction sliders 212 of the lever 206 with stay 252 (FIG. 9). The axial rod 186 (FIG. 4, FIG. 5) and counterweight 226 interaction without side forces provides rotor's guiding 232.

The axial rod 184 (FIG. 4, FIG. 6C) and inclined lever 206 interaction without side forces provides the sliders 198 of the lever 206 interaction with rotor guiding groove 196.

Thus the power strokes of the engine, pump and compressor are taking place simultaneously, with direct energy transfer, without any intermediate mechanisms and without a side force influence from the counterweight and lever. This increases the specific power and the hybrid longevity.

In work mode, the synchronize mechanism provides movement of the compressor piston and the rotation of the rotor, in synchronization with the piston-plunger movement, irrespective of the engine load or rate of acceleration.

In the hybrid, the weight and installation space are smaller than in the conventional system engine-pump thanks to the direct energy transmission.

The piston-plunger in BEP and the compressor piston in TEP simultaneously complete their power stroke. The air is compressed in the receiver to maximum pressure.

The piston-plunger movement from BEP to TEP (FIG. 15A, FIG. 15B, FIG. 15C) occurs simultaneously with the compressor piston movement from TEP to BEP, during a half revolution of the rotor. The compressor intake valve 98 is open and the air is sucked into the compressor chamber.

Because of its location on the side surface of the cylinder, the compressor intake valve diameter can be made much larger than the intake valve of a regular engine, with equal displacement volume. The intake air is cooler because it does not pass through the combustion chamber as with a conventional engine. This increases volumetric efficiency and air mass in the compressor chamber. Such joint factors improve the engine operation in all conditions and particular at low atmospheric pressure, for example, high above sea level.

The engine piston movement from BEP to TEP is comprised of three successive processes: combined clearing, joint compression, and finish compression (of the air in case of diesel, or of the mixture in case of gasoline engine) by the engine piston.

The combined clearing process (FIG. 15A) has three factors.

At first open the valve 82 and later opened the valve 78. The piston-plunger moves from BEP to TEP and displaces the burned gases (the first factor). During engine piston motion after the valve 78 open high pressurized fresh air, injected from the receiver through the open valve 78 also displaces the burned gases (the second factor). The clearing process provides the high-pressurized fresh air, which was compressed in the previous stroke while the engine piston moved downward.

This combined action intensifies the exhaust process and increases the volumetric efficiency. The additional cooling (intercooling) of air by the water jacket of the receiver is the third factor. Thus the three joint factors improve the filling process (of the air in case of diesel, or of the mixture in case of gasoline engine) and increase the specific power of the engine. The combined clearing process ends when the exhaust valve is closed.

The joint compression process is shown in the FIG. 15B.

The exhaust valve 82 is closed and the air injection valve 78 is open. The engine piston continues movement, and, jointly with the air injection, increases air pressure in the cylinder because the air pressure within the receiver is greater than that within the combustion chamber. The joint compression process ends when the injection valve is closed.

During the finish compression process (FIG. 15C) the valves 78, 82 are closed. The engine piston continues air compression. Before TEP, the air pressure in the cylinder becomes the maximum. A conventional fuel injection system (not illustrated) provides the start of the engine power stroke. So the new combined two-stroke cycle enables to realize maximum fuel efficiency with minimum emission and ends after one rotor revolution.

Thus the two-cycle engine of the hybrid uses inexpensive four-cycle engine cylinder head, with the intake valve functioning as an air injection valve and having different timing by comparison with four-cycle engine. This valve replaces conventional two-cycle engine cylinder wall air ports, and improves the two-cycle engine operation by use inexpensive air compressor. This solves the problem of boosting the two-cycle engine power by super high pressurized air injection and enables to realize a great potential possibility of a two-cycle engine—at least twice the specific power of a four-cycle engine with other things being equal.

The engine, compressor and pump operation is the function of the two independent arguments: first—the swash plate angle, second—the distance between the rotor centerline and the swash plate hinge pin axis. The first argument determines the engine, compressor and pump displacement volume. The second argument determines the engine compression ratio. The widely known engine compression ratio determines the kind of fuel (fuel octane rate) and determines a very important requirement: the engine compression ratio must be independent of the engine displacement volume change while the engine operates with the given fuel. This requirement executes in full the hybrid synchronize mechanism in accordance with the next proof based on diagrams (FIG. 16, FIG. 16A).

Proof of unique features: continuously variable displacement and independently continuously variable compression ratio of the hybrid engine.

The hybrid's compressor piston stroke h per half rotor revolution is equal to the axial rod stroke and in accordance with the widely know axial mechanism is

h=L tan Θ (1.1)

where L is the distance between axial rod axis, Θ—swash plate angle

The engine piston stroke H greater than the compressor piston stroke h in accordance with the lever ratio i=(a+b)/b where a, b is the lever arms.

H=ih=iL tan Θ (1.2)

where H is the engine piston stroke. Engine compression ratio Λ is

Λ=(δ+H)/δ (1.3)

where δ is the engine piston clearance
Let swash plate hinge pin axis is dispose on the line connecting an axial rod sphere centers. Then

Θ=0, H=0 and δ=0. (1.4)

The engine piston clearance δ is

δ=iε tan Θ (1.5)

where ε—distance between the axial rod and swash plate hinge pin axis.
The equations (1.2), (1.3), (1.4) and (1.5) defines the engine compression ratio.

Λ=1+L/ε (1.6)

### Because

ε=B−L/2 (1.7)

where B is the distance between the rotor centerline and the swash plate hinge pin axis. The equations (1.6) and (1.7) gives engine compression ratio.

Λ=(2B+L)/(2B−L) (1.8)

hence

B=L(Λ+1)/2(Λ−1) (1.9)

The proof gives us:
1. The engine compression ratio is independent of the swash plate angle Θ in accordance with equation (1.8). This is because both the engine piston stroke H and the clearance δ is proportional to the swash plate angle tangent (1.2),(1.5). This provides the engine operation with the variable displacement and invariable compression ratio during the swash plate angle θ alteration while the swash plate hinge pin is fixed (B=const).
2. The engine compression ratio is dependent on the distance B between the rotor centerline and the swash plate hinge pin axis in accordance with equation (1.8). This enables the different kind of fuel use and the engine transformation into an omnivorous engine by means of the distance B alteration.

### Numerical Example.

Let the distance between axial rods axis is L=60 mm and engine works with the compression ratio Λ=10 and the equation (1.9) gives B=36.7 mm.

If the other fuel requires two times greater engine compression ratio Λ=20 the equation (1.9) gives B=33.2 mm.

This example illustrate that the distance B small change determines great engine compression ratio alteration. Also this example illustrates the effective and easy method of the engine transformation into an omnivorous engine by means of the distance B alteration.

The FIG. 16 illustrates the minimum engine displacement volume in accordance with the minimum swash plate angle Θ. The FIG. 16A illustrates the maximum engine displacement volume in accordance with the maximum swash plate angle Θ incline.

The swash plate turn mechanism and swash plate turn hydraulic system provides of the engine operating with the variable displacement volume and the invariable engine compression ratio while the swash plate hinge pin is fixed.

The swash plate shift mechanism and swash plate shift hydraulic system provides of the engine operating with a different kind of fuel, and the engine becomes, in essence, an omnivorous engine.

The engine, compressor and pump variable displacement volume gives the additional ability of adapting the engine power to the automotives wider variable load and speed range.

The FIG. 17 illustrates the compressor piston stroke F₁ and the distance between compressor and engine pistons change from G₁ to K₁ during the half rotor revolution. This distance change determines the compressor displacement volume and the compressor compression ratio in accordance with the swash plate angle Θ₁ incline.

The FIG. 17A illustrates the compressor piston stroke F₂ and the distance between compressor and engine pistons change from G₂ to K₂ during the half rotor revolution. This distance change determines the compressor displacement volume and the compressor compression ratio in accordance with the greater swash plate angle Θ₂ incline.

The prime mover with two different sizes monocylindrical hybrid engines and with ability to activate and deactivate greater size monocylindrical hybrid engine provides extremely wide range of the engines displacement alteration for super efficient operation.

This wide range defines a continuously variable ratio of smaller and greater hybrids displacement sum to smaller hybrid minimum displacement in accordance with next calculation. Below is the calculation displacement ratio of the powertrain.

This calculation describes displacement ratio of a two different size monocylindrical hybrids association with continuously variable displacement volume and activating and deactivating greater size hybrid.

R=(V₁+V₂)/V₁^{min} (2.1)

where R is a two hybrid engines variable displacement ratio, V₁ is a smaller hybrid engine variable displacement, V₁ min is a smaller hybrid engine minimum displacement, V₂ is a greater hybrid engine variable displacement The

V₁=R₁V₁^{min} and V₂=R₂ V₂^{min} (2.2)

where R₁ is a smaller hybrid engine variable displacement ratio, R₂ is a greater hybrid engine variable displacement ratio The

V₂^{min}=KV₁^{min} (2.3)

where K is a ratio of a greater hybrid engine minimum displacement to smaller hybrid engine minimum displacement. Equation (2.1), (2.2), (2.3) gives displacement ratio of the powertrain

R=(R₁V₁^{min}+KR₂V₁^{min})/V₁^{min}=R₁+KR₂ (2.4)

hence the maximum displacement ratio of the powertrain is

R^{max}=R₁^{max}+KR₂^{max} (2.5)

The hybrid displacement ratio defines the swash plate incline angle. Let the smaller hybrid and greater hybrid has equal maximum incline angle displacement ratio

R₁^{max}=R₂^{max}=C (2.6)

hence equation (2.5) gives the maximum displacement ratio of the powertrain

R^{max}=C(1+K) (2.7)

### Numerical Example.

1. The engine piston stroke and the engine displacement is proportional to the tangent of swash plate incline angle (see above the proof of the independent change of engine displacement volume from the engine compression ratio). The maximum of swash plate incline angle is equal 18 degree (in accordance with “Sauer” company standard variable pumps) and the minimum of swash plate incline angle 7 degree gives C=2.65. If K=3.0 ratio R^{max}=10.6.

In case of diesel hybrid engine rotor revolutions change from 800 rpm to 2400 rpm the ratio of revolution is

Rᵣ^{max}=3.0 and R^{max}Rᵣ^{max}=31.8. (2.8)

Such an extremely wide range of the product displacement and cycle per min allows the preservation of the constant magnitude of the engines mean effective pressure during entire range of power alteration (from idling to maximum power) because the engine power is proportional to product of the mean effective pressure, engine displacement volume and engine cycle per min.

For example if the idling power is 5 hp, equation (2.8) gives the maximum power 159 hp due the engine displacement volume with the engine cycle per min alteration and constant load (mean effective pressure) of the prime mover. This causes super efficient operation in all conditions.

2. The difference of the engines size is a very important feature. In case of two equal displacement hybrid engines, K=1.0 and the equation (2.7) gives R^{max}=5.3. In case of two different size engines the ratio is R^{max}=10.6. Thus the combination of different size hybrid engines provides exponential increase of the monocylindrical hybrids maximum displacement ratio. In case of utilization of three different size hybrid engines the maximum displacement ratio of prime mover can be greater than 20. This is unique parameter of the super efficient powertrain.

Total Energy Recuperation.

The maximum output power of the regular engine determines the maximum acceleration magnitude of the vehicle so the standard mid-size car achieves 60 mph in about 10 sec by utilization of 200 hp engine. It is clear that smaller size engine can not provide the same result without breakthrough solution. Such a breakthrough solution is the total energy recuperation, which includes regenerative acceleration and regenerative braking and enables maximum decrease of the prime mover size.

Vehicle regenerative acceleration includes initial and final range and occurs during the accelerator pedal (not illustrated) depression. Because accelerator pedal electrically associated (not illustrated) with solenoid 416 (FIG. 11), valve 406 automatically switches to the regenerative acceleration position (FIG. 14A, FIG. 14B). The initial range of car acceleration occurs during low speed of the vehicle and low magnitude of required power (FIG. 13, FIG. 13A). The prime mover provides excess power by comparison with the required power for car acceleration. This occurs by increased cycle per min and increased displacement of the hybrids engine, compressor and pump.

The prime mover transmit power to the vehicle wheels by hydraulic motor and via ring gear and gear of the planet carrier. Simultaneously the sun gear transmit the excess power to the recuperating motor, which operate in the pump mode, charges the energy storage and forms stand-by energy. The sun gear rotates in opposite direction (FIG. 14B) relatively to the ring gear. So the prime mover operates with full load and high efficiency. The differential gear operates in the differentiator mode and spontaneously separates the power of prime mover to the car acceleration and to the energy storage charging.

During the energy storage charging the revolution of the sun gear decreases spontaneously, the gear of the planet carrier increase revolution and accelerate the car.

The initial acceleration range of the vehicle ends spontaneously when sun gear and the recuperating motor's shaft stop (FIG. 14C, FIG. 14D), the energy storage fluid pressure and stand-by energy achieves maximum magnitude and car achieves threshold of speed.

Threshold of speed is provided by fully loaded smaller size prime mover and maximum displacement (maximum torque) of hydraulic motor. The increase of threshold of speed requires power of the prime mover and additional energy.

During the final range of the car acceleration the threshold of speed is spontaneously increased by the stand-by energy (FIG. 14, FIG. 14E, FIG. 14F). When maximum car acceleration (the acceleration pedal maximum depressed) is required, the prime mover continues to activate the vehicle with maximum displacement and maximum revolutions by hydraulic motor also with maximum displacement. Simultaneously, the recuperating motor (also with maximum displacement volume), in capacity of second mover (motor mode) utilizes the stand-by energy and actuate the car jointly with the hydraulic motor. The recuperating motor shaft and hydraulic motor shaft rotates in the same direction. When maximum car acceleration is not required, the displacement volume of hybrid engines, hydraulic motor and recuperating motor is smaller than maximum displacement volume in accordance with less depression of the accelerator pedal.

During the final range of the car acceleration the differential gear operates in the integrator mode, summarize the engines power and stand-by energy and transmits the total power to car wheels by the planet carrier gear. Diagrams on FIG. 13 and FIG. 13A show the same car speed during same time T and the same required power. However, the partial loaded standard car engine (FIG. 13) has greater maximum power by comparison with fully loaded smaller size engine (FIG. 13A). In both cases the useful work of the different size prime movers is the same. Therefore the considerably smaller size fully loaded prime mover achieves the same result as large engine of the standard vehicle.

The calculation below describes how fully loaded small size prime mover can achieve the same result as partially loaded large size engine.

### Regenerative Acceleration Analysis.

This analysis based on mechanical work balance. Let the car acceleration magnitude A (m/sec²), car movement total resistance force F (kg.) (inertia force, rolling resistance force and air resistance force) and prime mover power are permanent. Prime mover power N₁ (h p) determines the car threshold speed V (m/sec.), η₁ is the transmission efficiency (from hybrid's pump output via hydraulic motor and differential gear to car wheels), and conversion factor is 1 h p=75 kg. m/sec. Hence the prime mover power is

N₁=FV/75 η₁ (3.1)

During the car acceleration initial range duration t (sec.) prime mover work on wheels is F V t=F A t² and work of the force F equal F L₁=0.5 F A t² where L₁ is the car travel distance (m) during acceleration initial range. During acceleration initial range the increase of energy storage (stand-by) energy E (kg. m) equals difference between prime mover work on car wheels and work of the force F, hence

E=(FVt−FL₁)η₂=0.5FAt²η₂ (3.2)

where η₂ is the recuperation system efficiency (from hydraulic motor via recuperating motor and differential gear to energy storage). The car acceleration final range duration is (T−t) where T (sec.) is the total regenerative acceleration duration. In this case the combined action of the prime mover work F V (T−t)=F A t (T−t) and stand-by energy 0.5 F A t² η₂² (where η₂² transfer efficiency in both pumping and motoring) equals the work of force F during the car acceleration final range. The mechanical work balance during acceleration final range is

FAt(T−t)+0.5FAt²η₂²=F(L−L₁)=0.5FA(T²−t²) (3.3)

where L is the car total travel distance during regenerative acceleration (m)
Using η₁=η₂=η the equation (3.3) becomes

(1−η₂²)t²−2Tt+T²=0, (3.4)

hence

t=T/(1+η) (3.5)

Using (3.1), (3.4), (3.5) the fully loaded prime mover power magnitude is

N₁=FV/75η=FAt/75η=FAT/(1+η)75η (3.6)

Because the standard engine power is

N=FAT/75η (3.7)

the equation (3.6) is

N₁=N/(1+η) (3.8)

The size of the fully loaded prime mover is (1+η) times smaller than size of standard car engine with the same car acceleration magnitude (because the engine power proportional to the engine displacement). If η=0.8 the engine displacement can be 1.8 times smaller. Thus preserves the acceleration magnitude of conventional car by utilizing the engine with considerable smaller size, weight and cost.

### Numerical Example.

The mid size car (such as Toyota Camry or Ford Taurus) with approximately same data such as overall height H=1.420 m, overall width W=1.850 m, weight G=1500 kg, engine N=200 h p and displacement 3L, achieves speed about V₁=60 mph (26.7 m/sec.) during T=10 sec. If the car acceleration is permanent then A=V₁/T=2.67 m/sec.²

The total resistance force is F=F₁+F₂+F₃ where F₁ is the rolling resistance force, F₂ is the air resistance force and F₃ is the inertia force. The F₁=0.015G=22.5 kg (0.015 is the factor of rolling resistance). The F₂=0.3H W ρ V₁²/2=0.15·1.417·1.854·0.1·26.7²=28.1 kg, where ρ=0.1 kg s²/m⁴ is the air density, 0.3 is the factor of air resistance and ρ V₁²/2 air resistance pressure. The F₃=G A/q=1500·2.67/9.81=408.2 kg where q is the acceleration of gravity. The total resistance force (according to car speed 26.7 m/s) is F=458.8 kg. A maximum required power of car wheels is 458.8 26.7/75=163.3 h p. This corresponds of the efficiency η₁=163.3/200=0.816 of transmission from engine output to car wheels.

This example illustrates that required acceleration determine the engine power magnitude. Hence mid size standard car engine utilizes 200 hp only when the vehicle achieves 60 miles per hour (26.7 m/sec.). During all time of car acceleration the engine operates with partial load causes low efficiency of the engine work.

The regenerative acceleration utilization allow mid size car to achieve the same acceleration magnitude by means of constant and fully loaded engine with N=200/(1+0.816)=110 h p (instead of 200 hp) if the transmission efficiency is η₁=0.816. Analysis of a regenerative acceleration gives us:

1. The regenerative acceleration enables us to utilize extremely smaller engine size. The size of the fully loaded prime mover is 1+η times (η is the recuperation system efficiency from energy storage via recuperating motor and differential gear to car wheels) smaller than size of partial loaded standard car engine with the same car acceleration magnitude.
2. The regenerative acceleration provides high efficiency engine operation and considerably decrease fuel consumption and emission in most heavy mode operation—car acceleration.

The recuperating system can be hydraulic or electric. The electric motor (not illustrated) with electric accumulator provides the plug in function.

The regenerative acceleration system also provides the function of the regenerative braking by utilization recuperating motor in the braking mode (pump mode) operation.

Both the regenerative acceleration and the regenerative braking increase stand-by energy.

Vehicle Regenerative Braking

Vehicle regenerative braking occurs during the brake pedal (not illustrated) depression. Because the brake pedal position electrically associated with solenoid 418 (FIG. 11) the valve 406 automatically switches to the regenerative braking position (FIG. 14G, FIG. 14H). During the brake pedal depression the hybrid engines operation occurs with decreased speed of pumps, simultaneously decreasing speed of the hydraulic motor and ring gear. The vehicle kinetic energy activate the recuperating motor 42, which (in the pump mode) charges the energy storage 408. This is how the vehicle regenerative braking (deceleration) occurs and transformation of the vehicle kinetic energy into potential energy of the energy storage. The regenerative braking returns only about 35 percent of the vehicle kinetic energy (about 60 percent of the vehicle velocity) due the energy losses. Thus the regenerative braking can not provide the necessary stand-by energy for subsequent entire vehicle acceleration. In contrast, the total energy recuperation provides the entire vehicle acceleration due to the regenerative braking and regenerative acceleration energy integration. The total energy recuperation enables to utilize 2.0 times smaller engine and to achieve the same acceleration magnitude by comparison with standard vehicle.

Extremely small size of the prime mover allows install driver seat at the vehicle fore and increase the vehicle interior space.

The total energy recuperation considerably decreases the fuel consumption.

Widely known specific fuel consumption (SFC) is used to describe the fuel efficiency of an engine design. The SFC is defined as fuel-flow per horsepower produced or this is the rate of fuel supply per cycle divided by the product of mean effective pressure and engine displacement volume in accordance with formula

SFC=S/MV (4.1)

where S is the fuel supply per cycle, M is the mean effective pressure and V is the engine displacement volume. Constant fluid pressure of load stabilizer determines constant mean effective pressure M. The unique wide range of engine displacement volume V alteration (which is proportional to the fuel supply per cycle S) provides constant SFC in accordance with formula (4.1). This process is controlled by on board computer.

Vehicle Reverse.

The operator switches reverse of the vehicle and (FIG. 11, FIG. 11J) solenoids 356, 432 and 418 respectively switches the first distributor, two-way valve and the valve to positions shown on FIG. 11J. The fluid flow from pump goes to the recuperating motor 42 and provides vehicle reverse movement by differential gear. The ring gear is on brake (brake not illustrated). Thus the valve 406 also provides the reverse vehicle movement.

Charging of the energy storage by prime mover pump.

If the energy storage fluid pressure is insufficient, the signal of the fluid pressure sensor switches solenoids 356, 432 (valve 406 is in neutral position). The pump charges energy storage to the same maximum fluid pressure as a fluid pressure of load stabilizer.

Charging of the Load Stabilizer.

The low fluid pressure magnitude of the load stabilizer initiate the signal from fluid pressure sensor (not illustrated) and on board computer (not illustrated) automatically switches on the distributor's 354 solenoid 356 (FIG. 11, FIG. 11G, FIG. 11H) and the solenoid 394 of the distributor 388. The fluid goes (while the hydraulic motor shaft is on brake) from energy storage via distributor 388 to the stabilizer motor inlet independently of the engine piston direction movement.

During the engine piston power stroke (FIG. 11G) the pump supply goes to the load stabilizer via the distributor 354. During the engine piston return stroke (FIG. 11H) the distributor 354 provides fluid supply to the pump inlet from replenishing system pump 172.

So the load stabilizer is charged by prime mover pump independently from operation of the greater size hybrid engine. The fluid pressure of load stabilizer determines the hybrid engines load and the hybrid engines mean effective pressure. If the fluid pressure achieves maximum, the electric signal from the sensor switches the solenoid 394 off (FIG. 11), the solenoid 392 on and distributors 388 switches to the idling position.

Thus the hybrid engine pump rapidly and automatically charges the load stabilizer. The electrohydraulic system provides permanent load of the prime mover by constant fluid pressure of load stabilizer. This permanent load is independent of the vehicle power alteration and this is the crucial factor of hybrid engines super efficient operation.

The hybrid powertrain has the following unique features of the hybrid engines: extremely wide range of continuously variable volume displacement change; activating and deactivating of the greater size engine; minimal and constant specific fuel consumption during entire range of the power change; total energy recuperation process including regenerative braking and regenerative acceleration; extremely compact design of a seven seats mid-size car instead of five seats without change of the overall width and length of standard car. All the above makes extremely cost-effective mid-size passenger car (about 1500 kg weight) and enables to achieve at least 80 mpg in city conditions.

The following illustrate the approximate fuel economy of the super efficient powertrain use in a car under city driving conditions by comparison with standard car.

| | Rate fuel |
|---|---|
| Method of the fuel economy | economy |
| 1. All modes operation with the minimum specific fuel | 20% |
| consumption | |
| 2. Direct energy transmission with the air intercooling | 8% |
| supercharger | |
| 3. Idling power decrease and engine shut down at every | 7% |
| red traffic light | |
| 4. Total energy recuperation | 40% |
| Total | 75% |

The super efficient hydraulic hybrid powertrain enables at least:
Utilization a two-cycle diesel engine or two-cycle gasoline engine. In case diesel is used, conventional system of injection pump and fuel injector into cylinder head (not illustrated) are used. In case gasoline is used, a conventional fuel injection system with spark plug into cylinder head (not illustrated) is used.
Using with various kinds of gaseous fuels such as propane, natural gas, methane, biofuel, hydrogen etc.
Using the standard electric motor and battery in capacity of recuperating motor and energy storage by simple retrofitting for the plug-in utilization.
Using the pressurized air in the receiver for other purposes, for example, pumping more air into the tires
Using the installation in machinery with either orientation of the engine cylinders axis and either orientation of the hydraulic motor: horizontal or vertical, or the either angle.
Using more than two monocylindrical hybrids engine, compressor and pump if required greater power of prime mover due the connection in parallel hybrid pumps with hydraulic motor or motors.
Retrofitting of existing vehicle's engine and transmission by more compact and cost-effective super efficient powertrain with more environment-friendly quality.

Thanks to the foregoing advantages the hybrid may be used in trucks, locomotives, boats, aircraft, portable power systems, construction machinery, motorcycles, automobiles and other kind of the automotive and equipment.

What is claimed as being new and desired to be protected by Letters Patent of the United States is as follows:

1. Superefficient hydraulic hybrid powertrain of a vehicle comprised at least two continuously variable displacement monocylindrical hybrids engine, compressor and pump forming prime mover having electrohydraulic controllers of displacement and hybrids size is different, hybrid pumps is connected in parallel with a load stabilizer and at least one hydraulic motor coupled by means of a differential gear with said vehicle wheels and energy recuperating motor forming second mover and associated with energy storage by valve connected in parallel to a hydraulic distributor and two-way valve.

2. The hybrid powertrain of claim 1 wherein said differential gear's ring gear connected to said hydraulic motor shaft, a sun gear connected to said recuperating motor shaft and a gear of a planet carrier mechanically coupled with said vehicle wheels and said variable displacement recuperating motor maximum displacement smaller than said variable displacement hydraulic motor maximum displacement in accordance with the ratio of sun gear to ring gear.

3. The hybrid powertrain of claim 1 wherein said hydraulic motor and said recuperating motor shafts axis located in horizontal plane, said hybrid engine cylinders located along one side of said vehicle and forms free space on the other side of said vehicle.

4. The hybrid powertrain of claim 3 wherein said free space of said vehicle is a place of driver individual seat and passenger seats arranged in two rows of seats with three seats in each row and form a seven seats mid-size car instead of five seats without change overall width and length of standard car.

5. The hybrid powertrain of claim 1 wherein said hybrid housings and said hydraulic motor housing fastened to one plate formed said hybrid pumps valve plate, comprises hydraulic canals hydraulicly connected said hybrid pumps to said hydraulic motor, which fastened to said recuperating motor by said differential gear housing and form said hydraulic hybrid powertrain solid monoblock.

6. The hybrid powertrain of claim 1 wherein said vehicle brake pedal electric associated with said valve solenoid of regenerative braking position, accelerator pedal electric associated with said valve solenoid of regenerative accelerating position and both pedals associated with said hybrids displacement electrohydraulic controllers for braking and accelerating control by means of said hybrid engines displacement alteration.

7. The hybrid powertrain of claim 1 wherein said hybrids engine, compressor and pump has initial different minimum displacements volume and acceleration pedal position determines a displacement ratio of said prime mover in accordance with formula R=C (1+K) where R is said prime mover continuously variable displacement ratio, C is a continuously variable displacement ratio of smaller size hybrid and K is a constant ratio of said greater hybrid minimum displacement volume to said smaller hybrid minimum displacement volume.

8. The hybrid powertrain of claim 1 wherein said prime mover size is smaller than standard car engine in accordance with formula S₁=S/(1+η) where S₁ is said prime mover maximum displacement volume, S is displacement volume of standard car engine and η is the recuperating transmission efficiency for preserving maximum acceleration magnitude of standard car by smaller size engine with total energy recuperation.

9. The hybrid powertrain of claim 1 wherein said prime mover continuously variable displacement magnitude proportional to said hybrid engines fuel supply per cycle for remain minimum said prime mover specific fuel consumption and pollution emission during entire range of require power change.

10. The hybrid powertrain of claim 1 wherein said load stabilizer fluid pressure magnitude is permanent and equal fluid pressure maximum of said energy storage for remain constant said hybrids engines mean effective pressure and preserve minimum said engines specific fuel consumption and emission in all conditions operation.

11. The hybrid powertrain of claim 1 wherein said monocylindrical hybrid engines comprises common cooling system and a cooling system pump mounted on said smaller hybrid engine for preserving optimal temperature of said prime mover independent of rapidly activating and deactivating said greater hybrid engine.

12. The hybrid powertrain of claim 1 wherein said monocylindrical hybrid engine comprises camshaft, conic reducer, chain drive and said compressor piston connected with one axial rod by hub and a counterweight, said engine piston fastened to pump plunger located within rotor and connected by crossbar and lever with second axial rod and both axial rods of a timing mechanism associated with a swash plate and an yoke coupled with a floating support mechanically connected by means of a pistons, springs and bearing with a suspension support located outside of said rotor.

13. The hybrid powertrain of claim 12 wherein said suspension support pivotable coupled with said swash plate by means of a rods and a turning levers and forms double-sided tie for said axial rods by said swash plate, said yoke, said floating support and said suspension support set for provide said engine and compressor pistons return stroke.

14. The hybrid powertrain of claim 12 wherein said swash plate and said suspension support connection forms said timing mechanism all force self-compensating for compact mechanism of said swash plate turn and shift control.

15. The hybrid powertrain of claim 12 wherein said swash plate associated with turn servocylinder and shift servocylinder mounted diametrically opposite relative said rotor center line and said swash plate shift servocylinder piston connected with said swash plate hinge pin by axle and lever which coupled with the axle by grooves and coupled pivotably with ledges of said swash plate shift servocylinder

16. The hybrid powertrain of claim 12 wherein said chain drive first sprocket wheel fastened to said rotor and associated by chain with a second sprocket wheel mounted by bearing and said chain drive housing on the side surface of said engine cylinder and connected with said engine camshaft by said conic reducer.

17. The hybrid powertrain of claim 12 wherein said counterweight mounted within said rotor by guiding for said engine piston and said plunger set inertia forces compensate without side force acting on said axial rod.

18. The hybrid powertrain of claim 12 wherein said axial rod comprises cylindrical ledges pivotably coupled with said lever and coupled with said rotor guiding grooves by means of sliders.

19. The hybrid powertrain of claim 1 wherein said valve is a four-way valve with solenoids having a first line and second lines connected to said recuperating motor, a third line coupled with a replenishing system and fourth line coupled with said energy storage

20. The hybrid powertrain of claim 19 wherein said valve having three position: regenerative acceleration position connected said first and said fourth lines and second line with third line, neutral position disconnected all lines and regenerative braking position connected said first and said third lines and second line with fourth line.

21. The hybrid powertrain of claim 1 wherein said hydraulic distributor is a three-way distributor with solenoids having a first line connected to said hydraulic motor outlet, second line coupled with said energy storage and third line connected to said load stabilizer and in the first position first line connected to third line and second line is disconnected, in neutral position all lines disconnected and in the third position first line connected to second line and third line is disconnected.

22. The hybrid powertrain of claim 1 wherein said two-way valve is a two-position valve coupled by a first line with said load stabilizer and second line coupled with said energy storage and in the first position first and second line is connected and in second position first and second line is disconnected.

23. A method of hydraulic hybrid powertrain operation comprising the steps of:
(a) Providing said prime mover adaptation to said vehicle wide range of load and speed with minimum fuel consumption by means of said engines displacement continuously and automatically alteration from minimum displacement smaller engine single operation to maximum displacement both engines jointly operation in accordance with the accelerator pedal depression, and
(b) Providing said prime mover adaptation to said vehicle wide range of load and speed with minimum specific fuel consumption by means of continuously and automatically hybrids displacement alteration and simultaneously automatically activating or deactivating greater size hybrid engine during the accelerator pedal or braking pedal depression, and
(c) Providing simple activating or deactivating said greater size hybrid engine by it fuel supply respectively switching on or switching off during of said smaller size hybrid engine operation and said monocylindrical hybrid pumps supercharges in parallel said hydraulic motor and said load stabilizer, and
(d) Providing said prime mover in all modes operation with minimum specific fuel consumption and permanent combustion mean effective pressure magnitude independent of said hybrid engines load and greater hybrid engine activating or deactivating by preserving permanent fluid pressure of said load stabilizer, and
(e) Providing said energy storage charging and stand-by energy forming by integrated action of regenerative braking and regenerative accelerating respectively during the brake pedal and accelerator pedal depression, and
(f) Preserving standard vehicle acceleration magnitude by extremely small size of said prime mover said differential gear provided said vehicle initial acceleration range and final acceleration range respectively during said energy storage charging and discharging, and
(g) Providing standard vehicle acceleration magnitude by means of extremely small size of said prime mover by said differential gear in the differential mode spontaneously transmits power to said vehicle wheels and via said recuperating motor to said energy storage during said vehicle acceleration initial range and during said vehicle acceleration final range said differential gear summarizes power of said energy storage and said prime mover and transmits to said vehicle wheels, and
(h) Providing said yoke, said floating support, said pistons, said suspension support, said rods, said turning lever and said swash plate interaction without clearance by means of a disc springs initial stress, and
(i) Providing said pump plunger and said hub interaction without side forces during interaction said pump plunger with said inclined lever said crossbar and sliders of said lever interacted in turn with counterweight and stay respectively in areas of said engine piston top end position and the bottom end position, and
